(19) United States
(12) Patent Application Publication
(10) Pub. No.: US 2026/0289200 A1
(43) Pub. Date: Sep. 24, 2026

(54) SYSTEM

(71) Applicant: SoftBank Group Corp., Tokyo (JP)

(72) Inventor: Koji SATO, Tokyo (JP)

(73) Assignee: SoftBank Group Corp., Tokyo (JP)

(21) Appl. No.: 19/567,159

(22) Filed: Mar. 15, 2026

(30) Foreign Application Priority Data
Mar. 19, 2025 (JP) 2025-045036

(51) Int. Cl. G06F 40/58; G06F 40/197

(52) U.S. Cl. CPC G06F 40/58; G06F 40/197

(57) ABSTRACT

A system includes a processor that is configured to distribute a specific template to a user, generate, by using a block-based language and based on a template selected by the user, a prompt sentence for instructing a generative AI model to perform a specific operation, apply compression to the generated prompt sentence to reduce token usage, recognize an emotion of the user and adjust at least one of generation of the prompt sentence and a compression rate of the prompt sentence in accordance with the emotion, and transmit the prompt sentence to the generative AI model and provide, to the user, a response received from the generative AI model.

### CROSS-REFERENCE TO RELATED APPLICATION

This application is based on and claims priority under 35 USC 119 from Japanese Patent Application No. 2025-045036 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for generating prompts for generative AI models rely heavily on manual, text-based input by users. As a result, users must understand how to formulate detailed and effective prompts, which creates a barrier for non-expert users and leads to variability in output quality. Furthermore, when long and complex prompts are used, token usage increases significantly, which raises cost and latency in generative AI processing. In addition, conventional systems generally do not dynamically adapt prompt generation or compression in response to the user's emotional state, and therefore cannot flexibly change the degree of explanation, tone, or compression according to the user's needs at a given time. Consequently, there is a need for a system that enables users, including non-expert users, to easily construct high-quality prompts using a block-based language, that automatically compresses prompts to reduce token usage while maintaining intended semantics, and that recognizes the user's emotion so as to appropriately adjust prompt generation and compression rate and improve interaction quality and processing efficiency.

### SUMMARY

In order to solve the above-described problems, an embodiment of the present invention provides a system comprising a processor, wherein the processor is configured to distribute a specific template to a user, generate, by using a block-based language and based on a template selected by the user, a prompt sentence for instructing a generative AI model to perform a specific operation, apply compression to the generated prompt sentence to reduce token usage, recognize an emotion of the user and adjust at least one of generation of the prompt sentence and a compression rate of the prompt sentence in accordance with the emotion, and transmit the prompt sentence to the generative AI model and provide, to the user, a response received from the generative AI model. In one embodiment, the processor is further configured to include, in the block-based language, a block for assigning a role of a specific expert and a translation block for translating content of the prompt sentence into a different language, thereby enabling easy construction of expert-role and multilingual prompts. In another embodiment, the processor is configured to improve processing efficiency of the system by reducing a number of tokens of the generated prompt sentence, for example by applying abbreviation rules or other compression techniques while preserving the essential instructions contained in the prompt.

The term “system” refers to a combination of at least one hardware device and associated software modules that cooperate to execute the processing described in the claims, including but not limited to a server device, a client device, or a distributed arrangement thereof.

The term “processor” refers to any hardware component or combination of hardware components capable of executing instructions, such as a central processing unit (CPU), a graphics processing unit (GPU), a microcontroller, or a set of such units operating together, and includes a processor executing software, firmware, or microcode implementing the claimed functions.

The term “template” refers to predefined data that specifies a structure or set of blocks usable by a user as a basis for constructing a prompt sentence, and includes identifiers, block definitions, and associated parameters used in the block-based language.

The term “user” refers to any human operator or entity that interacts with the system, for example through a terminal or client application, to select templates, arrange blocks, input parameters, and utilize generated prompts and responses.

The term “block-based language” refers to a representation for constructing instructions or prompt sentences using discrete visual or logical blocks, each block having a defined function or role and optionally including one or more parameters, such that a sequence or arrangement of blocks defines the content and structure of a prompt sentence.

The term “block” refers to a unit element of the block-based language that encapsulates a specific role, operation, transformation, or placeholder, and that can be combined with other blocks to form a prompt sentence.

The term “prompt sentence” refers to a sequence of text or symbols generated by the system based on one or more blocks and a selected template, the sequence being intended to instruct a generative AI model to perform a specific operation or set of operations.

The term “generative AI model” refers to a machine learning model, such as a large language model or similar artificial intelligence system, configured to generate text, code, or other content in response to input including a prompt sentence.

The term “specific operation” refers to a task or behavior requested from the generative AI model, such as explanation, translation, summarization, question answering, or domain-specific expert advice, as defined at least in part by the prompt sentence.

The term “compression” refers to processing applied to a generated prompt sentence that reduces the length, token count, or data size of the prompt sentence while substantially maintaining its intended semantic meaning and instructions for the generative AI model.

The term “token usage” refers to a quantity indicative of the number of tokens, subword units, or comparable units consumed by the generative AI model when processing a prompt sentence, and is typically related to computational cost and latency.

The term “compression rate” refers to a measure representing a degree or level of compression applied to a prompt sentence, for example a ratio of compressed length to original length, or a parameter determining how aggressively tokens are reduced.

The term “emotion” refers to an estimated affective state of the user, such as frustration, confusion, satisfaction, or calmness, inferred by the system using one or more modalities, including but not limited to textual input analysis, voice analysis, or behavioral signals.

The term “recognize an emotion of the user” refers to detecting or estimating the user's emotional state by applying one or more algorithms or models to data obtained from the user, such as textual content, interaction patterns, or sensor data.

The term “adjust the generation of the prompt sentence” refers to modifying at least one aspect of the prompt sentence creation process, such as length, level of detail, tone, or type of instructions, in response to the recognized emotion of the user.

The term “adjust a compression rate of the prompt sentence” refers to changing the degree or parameters of compression applied to the prompt sentence, such as making the prompt more compact or less compact, based on the recognized emotion of the user.

The term “response” refers to output content generated by the generative AI model in accordance with the prompt sentence, including but not limited to text, numerical values, explanations, translations, recommendations, or other machine-generated information.

The term “role of a specific expert” refers to a function or persona assigned to the generative AI model, such as a medical expert, legal expert, education expert, or technical specialist, which constrains or guides the behavior and style of responses of the generative AI model.

The term “translation block” refers to a block in the block-based language that, when included in a block sequence, specifies that at least part of the prompt sentence or related user content is to be translated from one language to another.

The term “content of the prompt sentence” refers to the textual or symbolic information encoded in the prompt sentence, including instructions, constraints, roles, and user-specific parameters intended for interpretation by the generative AI model.

The term “different language” refers to a natural language that is distinct from the original language of the relevant text or prompt content, such as translating from Japanese to English or from English to Spanish.

The term “processing efficiency of the system” refers to performance characteristics of the system, including at least one of reduced computational load, reduced processing time, reduced memory usage, or reduced consumption of tokens by the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

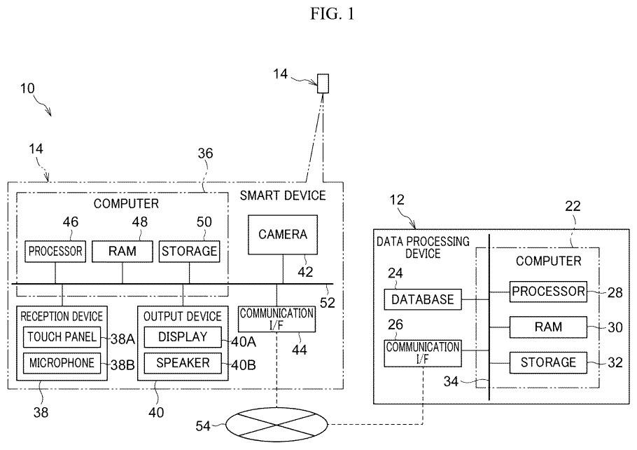

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

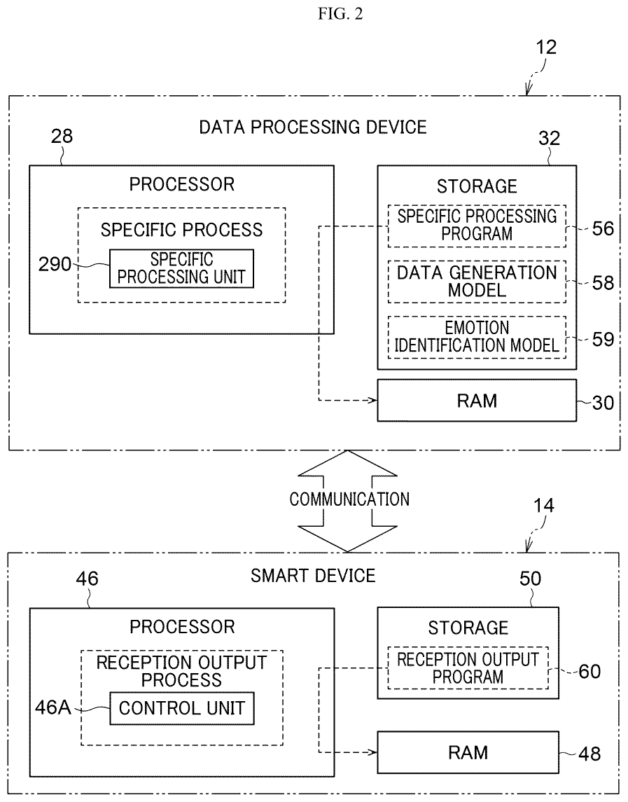

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for interacting with a generative AI model rely on a user manually composing a prompt sentence in natural language and directly submitting that prompt sentence to the generative AI model. Such systems suffer from several technical problems in the underlying computer technology.

First, when a user freely writes a prompt sentence in natural language, the prompt sentence tends to be verbose and redundant. As a result, a token sequence generated from the prompt sentence becomes unnecessarily long. In architectures where usage and latency of a generative AI model are strongly affected by the number of input tokens, such excessive token length causes increased computation time for inference, higher bandwidth consumption over a communication network, and higher utilization of processing resources such as central processing units, graphic processing units, and main memory. This leads to degraded overall throughput and responsiveness of the computer system.

Second, in conventional systems, the generative AI model interface is typically a single free-text field, and the computer does not have an explicit abstract structure representing the semantic roles, tasks, and output format embodied in the prompt sentence. Since the system lacks this intermediate abstract representation, the system is not able to systematically compress or normalize the prompt sentence at a structural level. Compression, if performed at all, is generally limited to trivial text shortening. As a result, the system fails to take advantage of structural regularities among prompts, and cannot consistently reduce token usage while preserving the intended semantics of the user's instructions.

Third, conventional systems do not provide a computer-managed, visual block-based mechanism for prompt construction that constrains user input to well-defined templates. Because the system simply accepts arbitrary text, the system cannot reliably infer intent, role designation, translation settings, or output constraints in a machine-readable manner. This limits the ability of the system to programmatically optimize prompts, to perform iterative refinement in response to user feedback, or to dynamically control compression based on system load or usage conditions. The lack of a block-based abstract structure also tends to increase user-side errors and inconsistent phrasing, which further degrades the efficiency of tokenization and model processing.

Fourth, existing system architectures generally apply fixed, non-adaptive preprocessing to prompts regardless of runtime conditions. Even if some form of compression or normalization is applied, the compression process is not dynamically controlled based on factors such as token count before and after compression, compression ratio, or current processing load of the generative AI model. Therefore, the system cannot balance prompt quality and computational resource usage, which leads either to insufficient compression (and thus high resource consumption) or excessive compression (and thus loss of important information).

Accordingly, there is a need for an improved computer-implemented system that introduces, at the system level, an intermediate abstract structure for prompt sentences via a visual block arrangement interface, and that applies a dynamic, rules-based compression process on token sequences corresponding to the prompt sentences. Such a system should reduce the token count of the prompt sentences in a controlled manner, adapt compression behavior based on measured token statistics and system conditions, and thereby improve processing efficiency, resource utilization, and responsiveness of a generative AI model in a computer environment, while still maintaining the semantic fidelity of user instructions.

The specific processing by the specific processing unit 290 of the data processing device 12 in Example 1 is realized by the following means.

The present invention provides a server comprising a processor configured to distribute, via a communication network, template information including generation block information for constructing a prompt sentence for a generative AI model to a user terminal, to receive, from the user terminal, a prompt sentence that is generated at the user terminal by a visual block arrangement interface that maintains the generation block information as an abstract structure in response to user operations, to calculate, for the received prompt sentence, a token sequence by performing segmentation corresponding to the generative AI model, to execute a compression process on the token sequence based on rules including reduction of redundant expressions, shortening of fixed expressions, and conversion into a structured representation indicating at least a role, a task, and an output format, thereby generating a compressed prompt sentence and obtaining a token count and a compression ratio before and after compression, to dynamically control the compression process by changing at least one of application, strength, and transformation rules of the compression process based on at least one of the token count before and after compression, the compression ratio, a processing load of the system, and a usage condition of the system, to transmit the compressed prompt sentence to the generative AI model and receive, from the generative AI model, a response text, to perform post-processing on the response text including at least one of formatting, structuring, and conversion of a display format, and to transmit a post-processed response text to the user terminal. This enables the computer system to represent user instructions as a structured set of generation blocks prior to natural language realization, to convert the resulting prompt sentence into a compressed form that preserves semantic roles and tasks while reducing token length, to adaptively regulate compression according to measured token statistics and runtime conditions, and thereby to reduce input token count to the generative AI model, improve throughput and latency of model inference, and enhance overall resource utilization efficiency while maintaining the quality and consistency of responses presented to the user.

The term “processor” refers to a hardware or virtual computation unit, including at least one central processing unit core, and optionally one or more accelerator units, that executes machine-readable instructions to perform the functions described in the present disclosure.

The term “server” refers to an information processing apparatus, including the processor, a storage device, and a communication interface, that provides services to one or more user terminals via a communication network.

The term “user terminal” refers to an information processing apparatus, such as a personal computer, a mobile terminal, or another electronic device, operated by a user and configured to transmit and receive data to and from the server via a communication network.

The term “communication network” refers to any wired or wireless data network, including local area networks, wide area networks, and public networks, that enables data transmission between the server and the user terminal.

The term “template information” refers to data distributed from the server to the user terminal that defines one or more reusable structures, including generation block information, used to construct a prompt sentence for a generative AI model.

The term “generation block information” refers to structured data that specifies at least one block type, one or more parameters, and a textual or symbolic pattern, the combination of which is used as a building unit for constructing a prompt sentence.

The term “visual block arrangement interface” refers to a graphical user interface executed on the user terminal that presents generation blocks as visual elements and allows a user to select, arrange, and edit the blocks through graphical operations.

The term “abstract structure” refers to an internal representation, such as a graph, tree, or other data structure, that expresses relationships among generation blocks, including their order, hierarchy, and parameter values, without being limited to a specific natural language expression.

The term “prompt sentence” refers to natural language text generated based on the abstract structure and intended to instruct a generative AI model regarding at least one of a role, a task, content to be processed, and an output format.

The term “generative AI model” refers to a machine-learned model, such as a neural network, that receives a prompt sentence as input and generates, by probabilistic inference, output data including at least one of text, symbols, or structured information.

The term “token sequence” refers to a sequence of discrete units, such as subword elements, symbols, or other segments, obtained by segmenting a prompt sentence using a tokenization method corresponding to the generative AI model.

The term “segmentation” refers to a process of converting a prompt sentence into a token sequence by applying a tokenizer or similar algorithm that maps characters or words into model-specific token units.

The term “compression process” refers to a series of operations executed on a token sequence or corresponding text for reducing the number of tokens while preserving intended semantics, the operations including at least one of removing redundant expressions, shortening fixed expressions, and converting text into a structured representation.

The term “redundant expressions” refers to portions of text or tokens that do not materially contribute to the semantics required by the generative AI model and can be omitted or shortened without substantially changing the intended instruction.

The term “fixed expressions” refers to frequently appearing phrases or template-like segments in prompt sentences that can be replaced by shorter equivalent expressions or symbolic representations.

The term “structured representation” refers to a machine-readable form, such as key-value pairs, labels, or tags, that explicitly indicates at least a role, a task, and an output format intended for the generative AI model.

The term “role” refers to an indication within the prompt sentence or structured representation that specifies a persona, expertise, or functional capacity under which the generative AI model is to generate a response.

The term “task” refers to an indication of a specific operation or action requested from the generative AI model, including but not limited to explaining, translating, summarizing, or analyzing content.

The term “output format” refers to a specification of a desired structure or style of the response generated by the generative AI model, including but not limited to headings, bullet points, paragraphs, or length constraints.

The term “compressed prompt sentence” refers to a prompt sentence that has been transformed by the compression process such that the number of tokens is reduced relative to the original prompt sentence while preserving the intended semantics.

The term “token count” refers to a numerical value indicating the number of tokens contained in a token sequence derived from a prompt sentence.

The term “compression ratio” refers to a value representing a relationship between a token count before compression and a token count after compression, including at least one of a quotient, a percentage, or a similar metric.

The term “processing load” refers to an amount of computational or communication resource usage in the system, including at least one of processor utilization, memory usage, input/output activity, and network bandwidth consumption.

The term “usage condition” refers to a state of operation of the system, including at least one of a number of active requests, a number of concurrent users, and a time-based or policy-based condition that influences how the compression process is applied.

The term “application of the compression process” refers to whether the compression process is executed for a particular prompt sentence or is omitted, based on system conditions or rules.

The term “strength of the compression process” refers to a degree or intensity with which compression is applied, including at least one of an extent of expression reduction, an extent of structure conversion, and a selection among multiple compression levels.

The term “transformation rules” refers to predefined or dynamically adjustable instructions used during the compression process to convert a token sequence or corresponding text into a compressed form.

The term “post-processing” refers to additional processing applied to a response text generated by the generative AI model, including at least one of formatting the text, structuring the text, and converting the text into a displayable format.

The term “response text” refers to text data produced by the generative AI model in response to a prompt sentence and optionally modified by post-processing before presentation to a user.

The term “display format” refers to a form in which text or other data is arranged for visual presentation on the user terminal, including at least one of plain text, formatted text, or structured display elements.

The term “user evaluation” refers to information derived from user interaction that indicates user satisfaction, appropriateness, or adequacy of a response text, including but not limited to explicit ratings, selection of options, or initiation of re-editing.

The term “re-editing request” refers to an operation performed by a user to modify an existing prompt sentence or underlying abstract structure, including at least one of adding blocks, deleting blocks, or changing block content.

The term “block configuration” refers to a set and arrangement of generation blocks in the visual block arrangement interface, including their order, nesting relationships, connection state, and parameter values.

The term “iterative process” refers to a repeated sequence of operations in which a user modifies a block configuration, the user terminal regenerates a new prompt sentence, the server performs compression and communication with the generative AI model, and a new response text is presented to the user.

In one embodiment, a server implements the claimed system as a network-accessible prompt optimization platform that communicates with at least one terminal operated by a user. The server includes a processor, a main memory, a non-volatile storage device, and a network interface. The server runs a general-purpose operating system, such as a Unix-like operating system, and application software implemented, for example, using a server-side framework. The server stores a set of template information and generation block information in a persistent storage, such as a relational database or a key-value store. The generative AI model is deployed either on the same server or on a separate inference server connected via a communication network.

The server stores the template information as data records, each record including an identifier of a generation block, a block type, parameter definitions, and a base text pattern. The server represents each generation block as a structured object including at least: a role type, a task type, an output format type, and one or more placeholders for user-specified content. The server associates the template information with version information and language information to support updates and internationalization.

The terminal operates as a client device, such as a personal computer, a tablet device, or a smartphone, including a display, a pointing input device or touchscreen, a local processor, a memory, and a network interface. The terminal executes a web browser or native application that includes a visual block arrangement interface. The terminal receives, from the server, the template information over a communication network using a communication protocol. The terminal parses the template information into an internal data structure, such as a tree or graph, and constructs visual block components corresponding to the generation blocks.

The terminal displays the visual block components in a block palette region on the display. The terminal accepts user operations such as drag-and-drop, tapping, clicking, and text input to select and arrange the blocks. The terminal maintains an abstract structure that represents the current configuration of blocks as a directed graph or tree structure, in which each node corresponds to a generation block and edges represent composition or sequencing relationships. The terminal stores parameter values entered by the user, such as a field of expertise, a topic, or a target language, as attributes associated with nodes in the abstract structure.

The terminal generates a prompt sentence by traversing the abstract structure according to a predefined traversal order, such as a depth-first traversal, and concatenating the base text patterns of the generation blocks with the user-specified parameter values. For example, the terminal may include a role designation block with the pattern “You are an expert in {field}.” and a task block with the pattern “Please explain {topic} in detail.”. When the user sets the field parameter to “modern European history” and the topic parameter to “the causes of World War II,” the terminal generates the following prompt sentence:

“You are an expert in modern European history. Please explain the causes of World War II in detail.”

The terminal may further combine a focus block and a format block, resulting in a prompt sentence such as:

“You are an expert in modern European history. Please explain the causes of World War II in detail. Focus on the Treaty of Versailles, the rise of fascism, and the policy of appeasement. Use headings and bullet points, and write about 800 words.”

The terminal displays the generated prompt sentence in a preview area and allows the user to iteratively adjust the abstract structure by manipulating the blocks. When the user is satisfied with the content, the terminal transmits the prompt sentence to the server as text data via the communication network.

The server receives the prompt sentence and performs tokenization using a tokenizer compatible with the deployed generative AI model. In one embodiment, the server implements a subword-based tokenizer that maps the prompt sentence into a token sequence comprising integer token identifiers. The server executes a segmentation algorithm that iterates over the characters of the prompt sentence, matches the longest valid subword units using a vocabulary, and outputs the corresponding token identifiers. The server counts the number of tokens in the token sequence to obtain a token count before compression.

The server applies a compression process to the token sequence and corresponding text using a rules-based transformation engine. The server maintains a rule set in memory, including at least: rules for detecting and replacing redundant expressions, rules for mapping fixed expressions to shorter canonical tokens or tags, and rules for constructing a structured representation that explicitly encodes a role, a task, and an output format. The server represents the structured representation as a key-value table or a label sequence, such as

“Role: history expert; Task: explanation; Focus: causes, events, consequences; Format: headings+bullet points; Length: ~800 words”.

The server identifies redundant expressions by scanning the token sequence for lexical patterns that do not significantly affect the intended semantics, such as repeated politeness phrases or verbose introductions. The server removes those portions or replaces them with shorter equivalents. The server identifies fixed expressions, such as “You are an expert in” or “Please explain,” and replaces them with compact control tokens or short tags such as “[ROLE_EXPERT]” or “[TASK_EXPLAIN]”. The server thereby generates a compressed prompt sentence, such as:

“Role: modern European history expert. Task: detailed explanation of causes of World War II. Focus: Treaty of Versailles, rise of fascism, policy of appeasement. Format: headings+bullet points. Length: ~800 words.”

The server re-tokenizes the compressed prompt sentence and obtains a token count after compression. The server computes a compression ratio by dividing the token count after compression by the token count before compression or by calculating a percentage difference. The server stores the token counts and compression ratio in a log for monitoring purposes.

The server dynamically adjusts the compression process based on the token counts, the compression ratio, and system load conditions. The server measures system load by sampling processor utilization, memory usage, and active request counts at predetermined intervals. For example, when the server detects that the token count before compression significantly exceeds a threshold, or that the system load is high, the server increases the strength of compression by enabling additional rules, such as more aggressive removal of filler phrases or more compact encoding of role and task information. Conversely, when the token count is low or the system load is low, the server may apply a weaker compression configuration to preserve additional contextual detail.

The server transmits the compressed prompt sentence to the generative AI model. In one embodiment, the generative AI model is a transformer-based neural network comprising an input embedding layer, multiple self-attention layers, feedforward layers, and an output projection layer. The generative AI model converts the token sequence derived from the compressed prompt sentence into embedding vectors and processes them through the multi-layer architecture. The generative AI model has been trained in advance using a large corpus of text data via gradient-based optimization, minimizing a loss function such as cross-entropy between predicted tokens and reference tokens. The training process updates weight parameters of the network using backpropagation and an optimization algorithm such as stochastic gradient descent or an adaptive gradient method.

The generative AI model uses the compressed prompt sentence, expressed as role and task tags, to condition its attention distribution and generate an output token sequence representing a response text. The generative AI model does not simply reflect the raw natural language, but interprets the structured representation and control tags to select appropriate patterns of behavior, such as adopting an expert tone, focusing on specified subtopics, and structuring the output into headings and bullet points. As a result, the compressed format improves computational efficiency by reducing the number of tokens processed by the transformer layers while maintaining or improving the consistency of responses.

The server receives the output token sequence from the generative AI model and converts it into a response text via a decoding operation that maps token identifiers back to subword units and characters. The server optionally performs post-processing on the response text. The server may apply formatting rules based on the requested output format, inserting line breaks, headings, and list markers according to the roles and tags embedded in the compressed prompt sentence. The server may also validate that the response text meets desired constraints, such as length or presence of bullet points, and may selectively trim or annotate the response text to match display limitations on the terminal.

The server transmits the post-processed response text to the terminal. The terminal displays the response text on the screen in a human-readable format. The terminal monitors user interactions with the displayed response and records user evaluation signals, such as a request for more detail, a request for simplification, or a decision to modify the prompt sentence. When the user elects to modify the prompt, the terminal presents the abstract structure with the existing block configuration, allowing the user to change role blocks, add translation blocks, or adjust format blocks.

The terminal may, for example, allow the user to insert a translation block with a pattern such as:

“Translate the following text into natural, polite business English: {source_text}.”

When the user sets the source text to “I have attached the materials for next week's meeting. Please review them.”, the terminal generates a prompt sentence such as:

“You are an expert translator. Translate the following Japanese text into natural, polite business English: I have attached the materials for next week's meeting. Please review them.”

The server compresses this prompt sentence to a structured form such as:

“Role: professional translator. Language: Japanese to English, polite business style. Text: I have attached the materials for next week's meeting. Please review them.”

The server transmits the compressed representation to the generative AI model. The generative AI model performs sequence-to-sequence translation using its learned parameters. The resulting response text may be:

“I have attached the materials for next week's meeting for your review.”

The terminal displays this translation to the user. The user may then further adjust blocks to, for instance, require a more concise or more formal output.

The server thereby implements a closed-loop optimization process in which the abstract block structure, token-level compression, and dynamic compression control collectively improve computational efficiency. By structurally representing prompts and compressing them into a role-and task-based control format, the server reduces the number of tokens processed by the generative AI model, minimizing memory access operations and matrix multiplications in the transformer's attention mechanism. This results in reduced latency and lower processing load on the server hardware. At the same time, because the compression rules preserve semantic roles and tasks, the system maintains or improves the consistency and quality of generated responses.

The described configuration is not a mere automation of human drafting of prompts. The server uses specific, non-conventional data structures (structured representations of role, task, and format) and a rule-based compression engine that operate at the token and control-tag level. Human users cannot easily replicate this token-level compression and dynamic adaptation based on system load without specialized computational resources. The server achieves improved technical performance by reducing bandwidth usage over the communication network, reducing the memory footprint of inference requests, and increasing throughput of the generative AI model.

In another embodiment, the server maintains multiple compression profiles, each profile corresponding to a different tradeoff between detail and efficiency. The server selects one of the profiles based on current system status metrics and the content type indicated in the abstract structure. For example, when the abstract structure indicates a translation task, the server may preserve more contextual tokens around the source text, while still compressing role and politeness information. When the abstract structure indicates a summarization task, the server may prioritize compressing descriptive instructions and leaving only concise directives.

In a further embodiment, the server may distribute model-specific template information to terminals corresponding to different generative AI models. In such a case, the server adjusts the generation block types and patterns to match the tokenization scheme and capabilities of each model. For a model with shorter maximum context length, the server may define more aggressive compression rules and more compact block patterns, whereas for a model with a longer context window, the server may allow more verbose instructions.

The terminal and server may be implemented using different hardware and software configurations without departing from the inventive concept. The terminal may be a lightweight device relying on server-side rendering, or a more powerful device executing a full-featured block editor locally. The generative AI model may be deployed on a dedicated accelerator platform, on a distributed cluster of accelerators, or as a managed cloud service. The underlying neural network architecture may include variations such as encoder-decoder transformers, sparse attention mechanisms, or mixture-of-experts layers, and may be trained using additional techniques such as curriculum learning, data augmentation, or reinforcement learning from human feedback.

In each of these embodiments, the core concept remains that the server uses the abstract block-based representation maintained at the terminal, performs token-level compression guided by explicit structural semantics (role, task, output format), and dynamically controls compression parameters based on measured token statistics and processing conditions. This combination of structural prompt representation, adaptive compression, and model-aware tokenization improves the operation of the computer system itself, enabling faster and more efficient interaction with a generative AI model while maintaining the usefulness and reliability of the generated responses for the user.

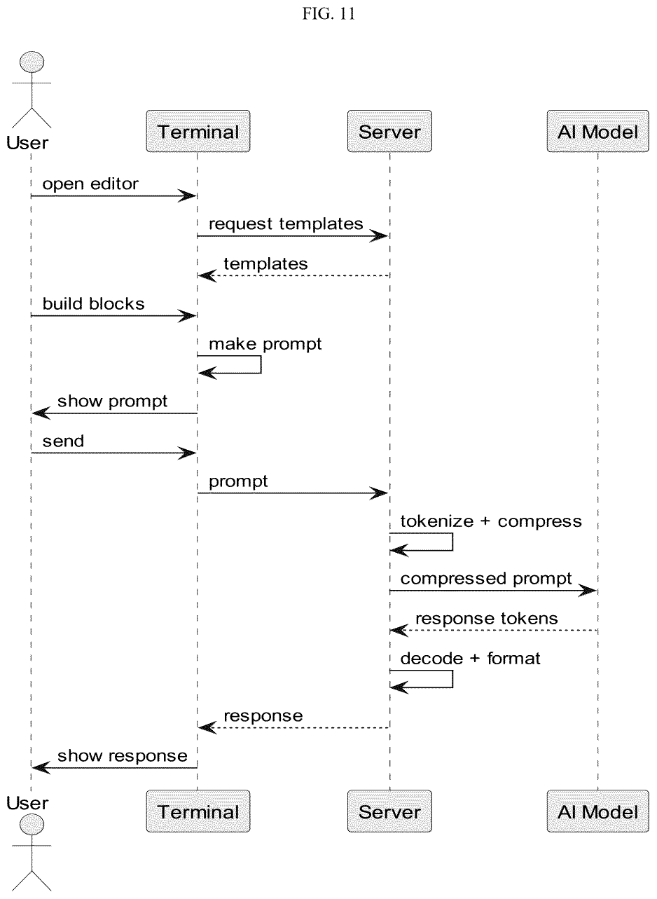

The following describes the processing flow using FIG. 11.

Step 1:

The server stores template information and generation block information in a storage device.

The server uses a database engine to register, as records, multiple block definitions including block identifiers, block types (role, task, format, translation, etc.), parameter definitions, and base text patterns.

Input: design data for generation blocks and templates.

Processing: the server converts the design data into a normalized data structure (for example, rows in relational tables or documents in a key-value store) and writes the data to persistent storage.

Output: a stored set of template information that can be retrieved later for distribution to terminals.

Step 2:

The server distributes template information to the terminal.

The server receives a request for template information from the terminal, queries the storage device using the request parameters (for example, language or model type), and retrieves corresponding generation block records.

Input: a template request from the terminal including at least a template identifier or category.

Processing: the server executes a search query on the database, aggregates the matching block records into a structured response object, and serializes the object into a transmission format.

Output: template information including generation block information sent to the terminal via a communication network.

Step 3:

The terminal builds an internal representation of the template information.

The terminal receives the template information, parses the serialized data, and instantiates visual block components and associated metadata in memory.

Input: template information including generation block definitions.

Processing: the terminal converts the incoming structured data into an internal object model (for example, a list or graph of block objects), maps each block definition to a visual element, and stores parameter constraints and default values.

Output: an initialized set of visual blocks and an abstract structure container ready for user operations.

Step 4:

The terminal displays a visual block arrangement interface to the user.

The terminal renders a block palette on the screen, where each generation block is represented as a graphical element with text labels and input fields for parameters.

Input: the internal block object model generated in Step 3.

Processing: the terminal creates user interface elements (for example, block-shaped components) for each block object, assigns event handlers for drag-and-drop and text input, and lays out the blocks in the palette region.

Output: a visible block-based editor interface that the user can manipulate.

Step 5:

The user constructs a block configuration by operating the terminal.

The user selects blocks from the palette, drags them to a workspace, connects or nests them according to intended semantics, and enters parameter values such as fields, topics, focus items, and target languages.

Input: displayed blocks and interface elements on the terminal.

Processing: the user performs physical actions (touch, click, drag) that the terminal converts into update events for the internal abstract structure, including creation of nodes for new blocks, update of node attributes for parameter values, and modification of edges representing order and hierarchy.

Output: an updated abstract structure representing the current configuration of generation blocks and their parameter values.

Step 6:

The terminal generates a prompt sentence from the abstract structure.

The terminal traverses the abstract structure according to a defined syntax rule and concatenates base text patterns with user-entered parameters to produce a natural language prompt sentence.

Input: the abstract structure containing block nodes and parameter attributes.

Processing: the terminal performs a traversal (for example, depth-first or topological order), for each block retrieves the corresponding base pattern text, replaces placeholder tokens (such as “{field}” or “{topic}”) with concrete parameter strings, and assembles the resulting segments into a single text string with proper punctuation and spacing.

Output: a generated prompt sentence, for example, “You are an expert in modern European history. Please explain the causes of World War II in detail. Focus on the Treaty of Versailles, the rise of fascism, and the policy of appeasement. Use headings and bullet points, and write about 800 words.”

Step 7:

The terminal presents the generated prompt sentence to the user for confirmation.

The terminal displays the prompt sentence in a preview area and allows the user to visually inspect the text and decide whether to proceed or to modify the block configuration.

Input: the generated prompt sentence from Step 6.

Processing: the terminal writes the text into a UI component (for example, a text box or read-only area), updates the display, and associates the prompt sentence with the current abstract structure state.

Output: a visible preview of the prompt sentence and a user decision point (confirm or edit).

Step 8:

The user confirms the prompt sentence and requests generation of a response.

The user operates a control element (for example, a “Send” button) to indicate that the prompt sentence should be submitted to the server for processing by the generative AI model.

Input: the displayed prompt sentence and the user's intention to use it.

Processing: the user action triggers an event on the terminal that marks the current prompt sentence as final for this iteration and initiates transmission to the server.

Output: a confirmed prompt sentence ready to be sent to the server.

Step 9:

The terminal transmits the prompt sentence to the server.

The terminal packages the prompt sentence and optional metadata (such as model type, language, and user identifier) into a request and sends it to the server over the communication network.

Input: the confirmed prompt sentence and associated metadata.

Processing: the terminal encodes the text and metadata into a message format, attaches necessary headers, and uses a network protocol to send the message to a designated server endpoint.

Output: a prompt submission request received at the server side.

Step 10:

The server tokenizes the received prompt sentence.

The server applies a tokenizer compatible with the generative AI model to convert the prompt sentence into a token sequence.

Input: the text prompt sentence from Step 9.

Processing: the server runs a segmentation algorithm that scans the prompt string from start to end, repeatedly selects the longest matching subword from a vocabulary, and maps each match to a token identifier; the server accumulates these identifiers into an ordered list.

Output: a token sequence representing the prompt sentence, and a token count before compression.

Step 11:

The server performs rules-based compression of the token sequence and corresponding text.

The server applies transformation rules to reduce redundant and fixed expressions and to transform parts of the prompt into a structured representation.

Input: the original token sequence and associated text prompt.

Processing: the server scans the token sequence to detect patterns that correspond to known phrases (such as “You are an expert in” or “Please explain”), replaces these with shorter control tokens or tags, removes tokens corresponding to non-essential politeness phrases, and constructs a representation that explicitly encodes the role, the task, the focus, and the output format; the server converts this representation back into a compressed prompt sentence text.

Output: a compressed prompt sentence, such as “Role: modern European history expert.

Task: detailed explanation of causes of World War II. Focus: Treaty of Versailles, rise of fascism, policy of appeasement. Format: headings+bullet points. Length: ~800 words.”, and a token count after compression.

Step 12:

The server computes and logs compression metrics.

The server calculates a compression ratio and records statistics for monitoring and later optimization.

Input: the token count before compression and the token count after compression.

Processing: the server computes numerical metrics such as the ratio of compressed tokens to original tokens and the absolute token reduction; the server writes these values, along with a timestamp and request identifiers, into a log or monitoring database.

Output: stored compression metrics associated with the processed prompt, ready for later analysis or adaptation of compression rules.

Step 13:

The server adjusts compression behavior based on system conditions.

The server evaluates current processing load, usage conditions, and the computed compression metrics to determine whether to modify the compression strength or rules for subsequent prompts.

Input: system monitoring data (CPU usage, memory usage, request queue length) and recent compression metrics.

Processing: the server applies decision logic that compares current values against thresholds; when thresholds are exceeded, the server updates internal parameters of the compression engine (for example, enabling more aggressive rule sets or lowering maximum allowed token count), and when values are under thresholds, the server relaxes compression to retain more detail.

Output: updated compression parameters that will be applied to future prompt sentences.

Step 14:

The server transmits the compressed prompt sentence to the generative AI model.

The server forwards the compressed prompt text or its token sequence to the generative AI model hosted locally or remotely.

Input: the compressed prompt sentence from Step 11.

Processing: the server converts the compressed prompt text into tokens if required by the model API, constructs a model input object including the token sequence and generation parameters (such as maximum output length), and sends this object to the generative AI model engine via an internal or external interface.

Output: a model inference request received by the generative AI model.

Step 15:

The generative AI model generates a response token sequence based on the compressed prompt sentence.

The generative AI model computes, layer by layer, output activations conditioned on the compressed prompt tokens and produces tokens for the response.

Input: the token sequence representing the compressed prompt sentence.

Processing: the model maps tokens to embeddings, applies multi-head self-attention and feedforward layers repeatedly, computes probability distributions over possible next tokens at each step, and selects tokens according to a decoding strategy such as greedy decoding or sampling; the model continues generating tokens until a stopping condition is met.

Output: an output token sequence corresponding to a response text.

Step 16:

The server decodes the response token sequence to obtain a response text.

The server converts the output token identifiers from the generative AI model into human-readable characters.

Input: the response token sequence from Step 15.

Processing: the server maps each token identifier back to a subword unit via the tokenizer vocabulary, concatenates the subword units to form words and sentences, and corrects any tokenization artifacts to produce a coherent text.

Output: a raw response text generated by the generative AI model.

Step 17:

The server performs post-processing on the response text.

The server applies formatting and structuring operations to align the response with the requested output format.

Input: the raw response text from Step 16 and the structured representation (role, task, format) derived from the compressed prompt sentence.

Processing: the server analyzes the response text, inserts line breaks, headings, and bullet markers according to the specified format, optionally enforces length constraints by trimming or summarizing segments, and converts the text into a display format compatible with the terminal's user interface.

Output: a post-processed response text suitable for presentation to the user.

Step 18:

The server transmits the post-processed response text to the terminal.

The server packages the post-processed response text into a response message and sends it back to the terminal.

Input: the post-processed response text and metadata (such as identifiers linking back to the original prompt).

Processing: the server constructs a response structure, encodes it for transmission, and sends it through the communication network to the requesting terminal endpoint.

Output: a response message containing the post-processed response text delivered to the terminal.

Step 19:

The terminal displays the response text to the user.

The terminal receives the response message, extracts the response text, and renders it in a display area.

Input: the response message from Step 18.

Processing: the terminal parses the message, reads the response text, updates the display layout if necessary (for example, adding scrollbars or headings), and shows the text on the screen for user review.

Output: a visible response corresponding to the user's original intent as expressed in the prompt sentence.

Step 20:

The user evaluates the response and optionally initiates refinement.

The user reads the displayed response and decides whether the result is satisfactory or requires modification of the prompt.

Input: the displayed response text and the user's perception of its adequacy.

Processing: the user may interact with controls such as “Edit prompt” or may directly manipulate the previously used blocks; the terminal converts these actions into update operations on the abstract structure, reusing or modifying existing blocks.

Output: either termination of the interaction when the user is satisfied, or a revised abstract structure that will produce a new prompt sentence.

Step 21:

The terminal regenerates and retransmits a revised prompt sentence when refinement is requested.

The terminal uses the updated abstract structure to produce another prompt sentence and restarts the submission cycle to the server.

Input: the modified abstract structure from Step 20.

Processing: the terminal executes the same generation procedure as in Step 6 to produce a new prompt sentence (for example, adding “Use simple language for elementary school students” or changing the task to “Summarize”), presents it to the user for confirmation, and upon confirmation, transmits it to the server as a new request.

Output: a revised prompt sentence sent to the server, leading to a new iteration of compression, model inference, and response generation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented content generation systems that utilize a generative AI model, a user is typically required to manually compose a prompt sentence in natural language. This manual prompt engineering process is cognitively demanding, highly variable in quality, and prone to ambiguities that cause the generative AI model to produce suboptimal or irrelevant output. As a result, the overall effectiveness of the computing system in transforming user intent into machine-processable instructions is degraded.

Furthermore, known systems transmit verbose, unstructured prompt sentences directly to a generative AI model without any systematic reduction of representational redundancy. Because current generative AI models operate on tokenized representations, excessive and inefficient prompt encoding results in an increased number of tokens per request, thereby increasing computational load, communication overhead, processing latency, and operating cost of the computer system. Existing compression techniques are not integrated in a manner that preserves prompt semantics while explicitly targeting token usage efficiency in interaction with a generative AI model.

Additionally, conventional interfaces generally ignore the emotional state of the user when constructing or optimizing a prompt sentence. In many scenarios, the user's emotional state such as confusion, frustration, or urgency can be inferred from interaction patterns or biometric indicators. However, conventional systems do not leverage such information to adapt the wording structure of the prompt sentence or to adjust compression behavior. Consequently, the computer system fails to optimize human-machine interaction and may further exacerbate user frustration, which, in turn, leads to unnecessarily repeated or inefficient queries that burden the underlying computational infrastructure.

Moreover, existing block-based or visual programming environments are not tightly coupled with server-side token-aware optimization for generative AI communication. While such environments can simplify program creation for users, they are not specifically designed to generate structured prompt data that is subsequently transformed, compressed, and managed by a server so as to improve the efficiency and robustness of the entire computer system, from user interface through network communication to AI inference backends.

Accordingly, there is a need for an improved computer-implemented system that (i) guides a user through the construction of a prompt sentence via a block-assembly language, (ii) converts block-level structured data into token-efficient prompt representations through controlled compression while maintaining semantic fidelity, and (iii) dynamically adjusts prompt wording and compression parameters based on an estimated emotional state of the user. Such a system should improve the functioning of the computer itself by reducing token usage, network load, and processing time, while also increasing the reliability and predictability of the generative AI model's responses.

The specific processing by the specific processing unit 290 of the data processing device 12 in Application Example 1 is realized by the following means.

The present invention provides a server comprising a processor configured to provide, to a user terminal, generation-support templates and configuration information of a block-assembly language, to receive, from the user terminal, structured data representing a prompt sentence constructed by the user through visual selection and arrangement of blocks based on the templates, to convert the structured data into a text-form prompt sentence and execute compression processing on the prompt sentence to reduce data length and a token usage rate while maintaining information content, to estimate an emotional state of the user on the basis of operation information or biometric information acquired from the user terminal, to dynamically adjust at least one of a wording structure of the prompt sentence and a compression ratio of the compression processing in accordance with the estimated emotional state, to transmit the compressed or reconstructed prompt sentence to a generative AI model and receive generated content from the generative AI model, and to transmit the generated content to the user terminal for visual presentation to the user. This enables the computer system to more efficiently and reliably convert user intent into machine-interpretable instructions, to reduce token-based computational and communication overhead when interacting with the generative AI model, and to adapt prompt generation and optimization behavior in response to user emotional state, thereby improving the overall technical performance, responsiveness, and robustness of the underlying information processing infrastructure.

The term “system” refers to an arrangement of one or more hardware devices and software components that cooperate to execute information processing operations as described herein.

The term “processor” refers to one or more hardware processing units, such as a central processing unit or a graphics processing unit, configured to execute instructions to perform the functions described in the claims.

The term “information processing device” refers to a computing apparatus, such as a server or backend computer, that performs centralized processing including prompt generation, compression, emotional state estimation, and communication with a generative AI model.

The term “user terminal” refers to a client-side computing apparatus, such as a smartphone, tablet, personal computer, or similar device, operated by a user to interact with the system.

The term “generation-support template” refers to a predefined data structure that specifies a base layout, sections, and guidance for constructing a prompt sentence, and that is provided to the user terminal to assist a user in generating instructions for a generative AI model.

The term “block-assembly language” refers to a visual or structural programming language in which functional elements are represented as blocks that can be selected, arranged, and connected to define the content and structure of a prompt sentence.

The term “configuration information of a block-assembly language” refers to data defining types, properties, and relationships of blocks, including syntax rules and display parameters, enabling the user terminal to render and handle block-based editing.

The term “visual block” refers to a graphical element displayed on a user interface that represents a specific function, parameter, or text fragment, and that can be visually manipulated to construct a prompt sentence.

The term “structured data” refers to machine-readable data, such as a tree or graph representation, that encodes the arrangement, hierarchy, and parameters of visual blocks corresponding to a prompt sentence.

The term “prompt sentence” refers to a natural language or structured text string provided to a generative AI model as an instruction or query to cause the model to generate content.

The term “text string” refers to a sequence of characters represented in a coded character set, such as a character encoding, that expresses a prompt sentence in textual form.

The term “compression processing” refers to a procedure executed by a processor to reduce the size of data representing a prompt sentence, using an algorithm that removes representational redundancy while preserving essential information.

The term “data length” refers to a quantitative measure of the amount of data, such as the number of bytes or characters, required to represent a prompt sentence before or after compression processing.

The term “token usage rate” refers to a quantitative measure of the number of tokens consumed by a prompt sentence or related data when processed by a generative AI model.

The term “operation information” refers to data representing interactions of a user with a user terminal, including events such as keystrokes, pointer movements, touch actions, editing operations, timing patterns, or similar input behaviors.

The term “biometric information” refers to data derived from a user's physiological or behavioral characteristics, such as heart rate, facial expression, voice characteristics, or eye movement, that can be used to infer an emotional state.

The term “emotional state” refers to an inferred condition of a user's affect or mood, such as frustration, confidence, confusion, or urgency, estimated from operation information, biometric information, or a combination thereof.

The term “wording structure” refers to a configuration of textual elements in a prompt sentence, including sentence order, phrasing style, level of detail, and choice of terms used to express instructions to a generative AI model.

The term “compression ratio” refers to a value expressing a relationship between sizes of data before and after compression processing, used to control the degree to which a prompt sentence is compressed.

The term “generative AI model” refers to an information processing model, such as a machine-learned model, that receives a prompt sentence and outputs generated content including text, images, or other data.

The term “generated content” refers to information output by a generative AI model in response to a prompt sentence, including but not limited to textual explanations, guides, descriptions, or other media representations.

The term “display data” refers to data that has been formatted or transformed to be presented visually on a display unit of a user terminal.

The term “role-setting block” refers to a type of visual block that specifies a role or persona to be assigned to an information processing model within a prompt sentence, such as indicating an expert domain or function.

The term “translation-processing block” refers to a type of visual block that specifies that contents of a prompt sentence are to be converted from one language to another by a processing function or model.

The term “information processing model” refers to a computational model, including but not limited to a generative AI model, that receives an input such as a prompt sentence and produces an output based on learned or predefined behavior.

The term “representational redundancy” refers to repeated or non-essential portions of data in a prompt sentence that can be removed or reduced without altering the essential semantic content required by a generative AI model.

The term “communication with the generative AI model” refers to an exchange of data between an information processing device and a generative AI model, including transmission of prompt sentences and reception of generated content.

In one embodiment, a server cooperates with one or more terminals operated by users to implement a system for constructing, optimizing, and transmitting a prompt sentence to a generative AI model. The server includes at least one processor, a memory, a network interface, and a non-transitory storage medium. The server executes software components implemented, for example, in a server-side framework such as a general-purpose web application framework running on an operating system. The server may be deployed on hardware such as a rack-mounted computer including a multi-core central processing unit (CPU) and, optionally, a graphics processing unit (GPU) accelerator. The terminal includes at least one processor, a memory, an input interface such as a touchscreen or pointing device, and a display device such as a liquid crystal display or organic light-emitting diode display. The terminal executes a client application, which may be implemented as a web browser application using a browser engine such as a standards-compliant rendering engine, or as a native mobile or desktop application.

The server stores generation-support templates and configuration information of a block-assembly language in the storage medium. The server represents each template as structured data, for example in a hierarchical text-based format, defining sections such as a role definition, task description, constraints, language settings, and output formatting preferences. The server represents the block-assembly language configuration as a set of block type definitions, including block identifiers, input fields, connection rules, and associated text fragments. The server transmits these templates and block configuration data to the terminal through an application programming interface (API) over a secure transport protocol via the network interface.

The terminal receives the template data and block configuration data, stores them in a local memory region, and renders a visual editing environment. The terminal uses a visual programming library, such as a block-based editor library, to display visual blocks corresponding to the template elements. Each visual block encapsulates metadata including a block type, user-editable parameters, and references to text fragments that will later be concatenated into a prompt sentence. The terminal displays these blocks on the display device and allows the user to manipulate them by drag-and-drop operations, parameter input, and connection or disconnection of blocks.

The user operates the terminal to select a template, for example a “Travel Guide” template, and to assemble blocks to form a desired prompt structure. The user may select a role-setting block, a task-description block, and a translation-processing block, and may input specific parameters such as a city name or a desired output language. For instance, the user may enter “Tokyo” as the city and request bilingual output. The terminal maintains an internal representation of the block arrangement in a structured data format such as a tree-structured or graph-structured object, which acts as an abstract syntax tree (AST) of the prompt structure.

The terminal converts the structured data representing the block arrangement into a prompt sentence. The terminal traverses the AST in a deterministic order, for example by a depth-first or topological traversal, and constructs a text string by concatenating text fragments associated with each block and inserting user-provided parameters. The terminal may normalize whitespace, enforce punctuation rules, and apply template-specific phrase ordering. In the travel guide example, the terminal generates a prompt sentence such as:

“You (AI) are a travel expert. Based on the following information, please create a sightseeing guide for Tokyo. Apply translation here.”

The terminal can present this prompt sentence to the user as a preview on the display device, enabling the user to verify and refine the wording without requiring the user to write the entire prompt manually.

The server receives from the terminal the structured data, the generated prompt sentence, or both. In one embodiment, the terminal transmits the structured data and the server performs the final conversion into text. In another embodiment, the terminal transmits the finished prompt sentence directly. The server encodes the prompt sentence as a sequence of bytes (for example, in a standard character encoding format) and applies compression processing using a lossless compression algorithm such as a DEFLATE-based method. The server may call a compression library, which transforms the byte sequence into a compressed binary representation. If the downstream generative AI model interface requires textual content, the server may further encode the compressed data into a textual representation such as a base encoding.

The server maintains a token usage model that estimates the number of tokens a generative AI model will consume based on the length and structure of the prompt sentence. The server may maintain, in memory, a mapping between character sequences and token counts corresponding to the tokenization scheme of the generative AI model. By applying compression and, when appropriate, replacing repeated phrases with compact markers that are expanded only on the server side, the server reduces the number of tokens that need to be transmitted to or processed by the generative AI model. This reduction in token usage leads to lower bandwidth usage on the network interface, reduced memory consumption in the model-serving environment, and improved throughput, which constitutes a technical improvement in the functioning of the underlying computing infrastructure.

The server also acquires operation information and, when available, biometric information from the terminal. The terminal can collect operation information such as input timing patterns, frequency of block rearrangements, repeated deletions or undo operations, and prolonged hovering over help icons. The terminal may additionally collect biometric information, such as facial expression features obtained from the camera, speech prosody features from the microphone, or heart rate data from a connected wearable device, when permitted by the user and system policy. The terminal transmits such information, in anonymized or pseudonymized form when appropriate, to the server.

The server estimates an emotional state of the user based on the operation and biometric information. The server can employ a neural network model specifically trained for emotion classification. In one implementation, the server uses a multi-layer neural network with an input layer that accepts engineered features such as keystroke intervals, pointer velocity statistics, gaze fixation duration, and spectral features of voice; intermediate layers that include fully connected layers and non-linear activation functions; and an output layer producing scores corresponding to emotional categories such as “confused,” “frustrated,” or “confident.” The server trains this model offline using supervised learning with labeled behavioral and biometric datasets. During training, the server applies an error function, such as cross-entropy loss, and updates the model weights using an optimization algorithm such as stochastic gradient descent or a variant thereof. The server may perform data augmentation, for example by adding noise to timing features or simulating slight variations in biometric signals, to improve robustness.

At runtime, the server processes input features derived from the current user's interaction and biometric signals through the trained neural network to obtain an estimated emotional state. The server then adjusts technical parameters of the prompt generation and compression pipeline based on this estimate. For instance, when the user appears confused or frustrated, the server can instruct the terminal to present more explicit, step-by-step templates and may reduce the compression ratio to preserve more explicit text redundancy, thereby making the prompt and subsequent responses more transparent and interpretable. Conversely, when the user appears confident and experienced, the server may apply more aggressive compression parameters to minimize token usage while maintaining semantic equivalence, thereby accelerating processing and reducing resource consumption.

The server modifies the wording structure of the prompt sentence according to rules encoded in software modules. These rules can specify that, for a confused emotional state, the server should expand abbreviations, add clarifying phrases, and insert explicit constraints and examples within the prompt sentence. For a confident state, the server may remove redundant explanation blocks and compress common phrases into more concise equivalents. Such rules operate over the AST representation of the prompt sentence or over a structured intermediate representation of sentence segments. This structured manipulation is not a mere automation of human editing but leverages machine-specific data structures and algorithms to reorder, expand, or compress content according to the estimated emotional state and measured token efficiency. As a result, the server systematically controls the trade-off between human readability and computational efficiency, implementing a non-conventional technical approach distinct from manual editing.

The server transmits the compressed prompt sentence, or a reconstructed prompt sentence that has been optimized for token usage, to the generative AI model. The server communicates with the generative AI model via an application programming interface over a secure network connection. The generative AI model may be implemented as a transformer-based neural network deployed on specialized hardware such as GPU clusters or tensor processing units. The model converts the prompt sentence into tokens by applying a tokenizer, maps tokens to embedding vectors, and processes the sequence through multiple layers of self-attention and feed-forward transformations. Each layer comprises weight matrices, bias vectors, and non-linear activation functions. The model has been trained in advance on large-scale text data using a language modeling objective, minimizing a loss function such as cross-entropy by adjusting weights through backpropagation and gradient-based optimization.

The server can further refine communication with the generative AI model by controlling parameters such as temperature, maximum token count, and stop sequences, which influence the model's generation behavior. The server may adapt these parameters in conjunction with the emotional state estimate; for example, the server can reduce temperature to produce more deterministic and stable outputs when the user is frustrated, reducing variance in responses and thereby lowering the probability of repeated correction cycles. This adaptive control improves the overall efficiency of the computing system and reduces unnecessary invocations of the generative AI model.

The generative AI model returns generated content to the server. The server receives the content as a sequence of tokens or as a text string encoded in a network-friendly data format. The server transforms the content into a structured representation, identifies sections such as introductions, lists, and summaries, and may add metadata tags for headings and emphasis. The server may apply post-processing techniques such as sentence segmentation, language detection, and, when required, translation through a dedicated translation engine or through another specialized model, in accordance with the translation-processing blocks selected by the user.

The terminal receives the final generated content from the server and renders it on the display device. The terminal can apply formatting rules derived from the original template, such as showing section headers, bullet lists, or emphasized key points. The terminal allows the user to scroll, search within the generated content, and copy or export portions as needed. When the user modifies the block configuration on the terminal and initiates a new generation cycle, the terminal and server reuse the same session context, which can be maintained by a session identifier stored on both sides. This session context allows the server to apply caching strategies, such as storing normalized prompt ASTs and their corresponding compressed representations and responses in an in-memory data store. When a substantially similar prompt appears, the server can reuse prior compressed data or even generated content, thereby reducing computational load and response time.

The use of a block-assembly language and template-driven prompt construction produces a structured, machine-readable representation of user intent that is well suited for algorithmic optimization. The server and terminal exploit this structure to perform operations that are difficult or impossible to perform reliably on arbitrary free-form natural language prompts. In particular, the server can analyze the AST of the prompt sentence, detect redundant or repeated subsequences, and encode them via reusable tokens or macros, which significantly reduces token usage within the generative AI model. This structured compression results in a measurable decrease in the number of tokens processed per request, which directly reduces processing time and computational cost at the AI inference hardware level and reduces network bandwidth consumption between the server and the model endpoint. These technical improvements are a consequence of the specific data structures, compression strategies, and model control mechanisms implemented by the server, and are not merely a business or workflow optimization.

In another embodiment, the server and terminal may be integrated into a single physical device, such as a standalone workstation. In this case, the device still employs the same internal modular architecture: a user-interface module for block-assembly editing, a prompt synthesis module for AST traversal and text string generation, a compression module for token-efficient encoding, an emotional state estimation module using operation and biometric features, and an AI communication module for interacting with a local or remote generative AI model. The internal data flow among these modules follows the same structure described above, and the technical effects, reduced token usage, improved responsiveness, and dynamic adjustment based on user emotional state, are preserved.

In yet another embodiment, the system can be deployed in a distributed computing environment where multiple servers share the workload of compression, emotion estimation, and model invocation. In such a configuration, a first server may specialize in receiving structured data and performing emotion estimation, a second server may specialize in compression and token optimization, and a third server may manage communication with the generative AI model cluster. The system can use message queues or similar mechanisms for inter-server communication, and the same data structures and algorithms for AST-based prompt management and token-aware compression can be applied across nodes. This distributed architecture further enhances scalability, reliability, and throughput, particularly in large-scale deployments where many users simultaneously generate prompt sentences.

Through these embodiments, the server, the terminal, and the generative AI model cooperate to implement a specific sequence of technical processes: structured prompt construction via visual blocks, token-efficient compression tailored to the model's tokenization scheme, dynamic adaptation based on an estimated emotional state derived from measurable user behavior and biometric signals, and optimized communication with a transformer-based generative AI model. This configuration yields concrete technical benefits, including reduced computational cost, lower network traffic, faster response times, and improved consistency and clarity of AI-generated content, thereby improving the functioning of the underlying computer systems beyond mere automation of a human mental process.

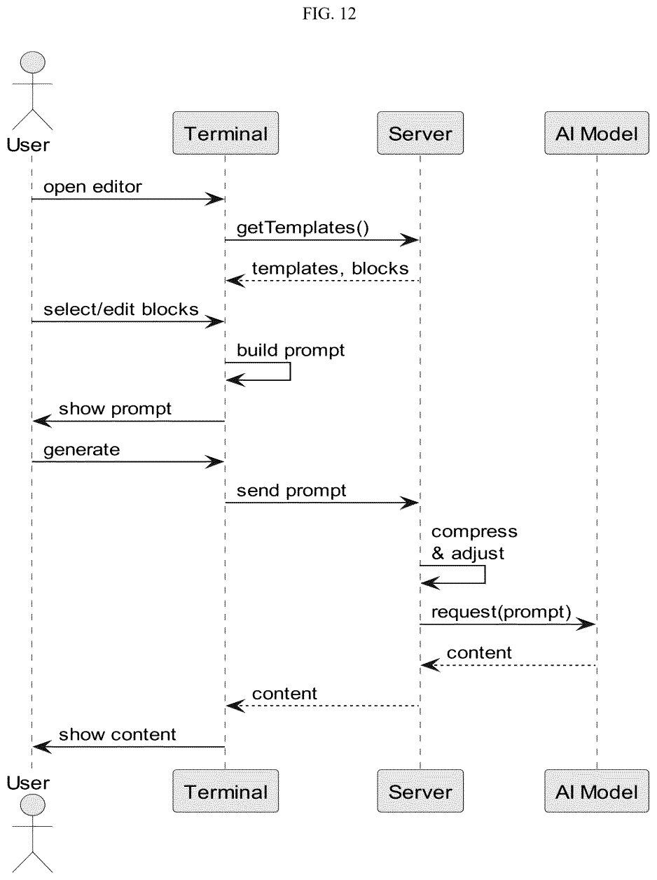

The following describes the processing flow using FIG. 12.

Step 1:

The server prepares and stores generation-support templates and block-assembly language configuration.

The server uses a storage device to store template data and block type definitions as structured records (for example, hierarchical text-based records). The input to this step is predefined design information describing roles, tasks, constraints, and block types. The server converts this design information into machine-readable data structures, such as key-value records and lists, and writes them into persistent storage. The output of this step is a set of retrievable template records and block-configuration records that can later be transmitted to the terminal.

Step 2:

The terminal requests templates and block configuration from the server.

The terminal sends a request message through a network interface to the server's template API. The input to this step is a user action, such as launching the prompt-construction screen, and a session identifier stored in the terminal. The terminal packages the session identifier and request type into a network message and transmits it. The output is a request packet that can be processed by the server to retrieve appropriate template and configuration data.

Step 3:

The server transmits templates and block configuration to the terminal.

The server receives the request packet, parses the requested resource type and session identifier, and looks up the corresponding template and block-configuration records in storage. The input to this step is the parsed request and the stored records. The server reads the records from storage, serializes them into a structured response format, and sends them back through the network interface. The output is a response packet containing template definitions and block-assembly language configuration.

Step 4:

The terminal renders a template list and a block-assembly environment.

The terminal receives the response packet, parses the template list and block-type definitions, and loads them into memory structures such as arrays and maps. The input to this step is the serialized template and block data. The terminal generates visual components for each template (for example, cards with title and description) and initializes a block workspace using the block-type definitions. The terminal then displays the template list on the display device. The output is a visible user interface showing available templates and an initialized block-editing area ready for further operations.

Step 5:

The user selects a template to define the overall prompt structure.

The user interacts with the terminal by tapping or clicking on one of the displayed templates. The input to this step is the visual template list and the user's selection action. The terminal captures the selection event, identifies the template identifier associated with the selected item, and updates its internal state to mark this template as active. The output is a selected template identifier stored in the terminal's memory and used to configure subsequent block layout and parameters.

Step 6:

The terminal constructs an initial block layout based on the selected template.

The terminal reads the selected template definition from its in-memory data structures. The input to this step is the template identifier and the corresponding template record that specifies required sections, recommended roles, and optional translation features. The terminal instantiates visual blocks representing these sections (for example, role-setting blocks, task description blocks, and translation-processing blocks), positions them in the workspace, and sets default parameter values. The output is an initial block-assembly workspace where each block is represented as a node in an internal graph or tree structure and as a visual object on the display.

Step 7:

The user edits the block arrangement and parameters to express intent.

The user manipulates blocks on the terminal by dragging, dropping, connecting, and deleting them, and by entering parameter values such as city names, languages, or detail levels. The input to this step is the initial block layout and the user's interactive operations. The terminal captures each event (e.g., drag start, drop position, text input) and updates the internal structured representation of the workspace, such as an abstract syntax tree or a graph of connected nodes with associated parameter values. The output is an updated structured representation that encodes the user's intended prompt structure and content, along with a visually updated workspace.

Step 8:

The terminal generates a prompt sentence from the structured block representation.

The terminal invokes a text-synthesis routine that traverses the internal structure of blocks. The input to this step is the abstract syntax tree or graph containing block types, ordering, and user-entered parameters. The terminal performs a deterministic traversal (for example, depth-first in a specified sequence) and, for each block, retrieves associated text templates and inserts parameter values. The terminal concatenates these text fragments, normalizes whitespace, and inserts punctuation where required to form a coherent prompt sentence. The output is a prompt sentence represented as a text string in memory.

Step 9:

The terminal presents a preview of the generated prompt sentence to the user.

The terminal reads the generated text string from memory and displays it in a text area near the block workspace. The input to this step is the prompt sentence string. The terminal may apply simple formatting rules, such as line wrapping and font selection, and updates the display buffer accordingly. The output is a visible preview of the prompt sentence, enabling the user to confirm that the text matches the intended instruction to the generative AI model.

Step 10:

The user confirms the prompt sentence and initiates content generation.

The user activates a control element, such as a “Generate” button, indicating that the current prompt should be processed by the server. The input to this step is the displayed prompt sentence and the user's confirmation action. The terminal detects the button activation, sets a flag indicating confirmation, and prepares to transmit the current prompt sentence and associated metadata. The output is a confirmed prompt state and a trigger for network transmission to the server.

Step 11:

The terminal transmits the prompt sentence and context information to the server.

The terminal packages the prompt sentence, the template identifier, and session-related metadata into a request object. The input to this step is the confirmed prompt text and contextual data (e.g., language settings, desired output length). The terminal serializes this request object into a network message and sends it through the network interface to the server. The output is a structured request packet containing the prompt sentence and metadata ready for server-side processing.

Step 12:

The server validates the request and logs necessary information.

The server receives the request packet, parses the contained fields, and checks for completeness and consistency. The input to this step is the serialized request from the terminal. The server verifies that required fields such as prompt sentence, template identifier, and session identifier are present and structurally valid. The server then records metadata, such as timestamps and anonymized session identifiers, in a logging subsystem for monitoring and debugging. The output is a validated request and a log entry that reflects the processing event.

Step 13:

The server applies compression processing to the prompt sentence to reduce token usage.

The server obtains the prompt sentence text from the validated request and converts it into a sequence of bytes using a character encoding. The input to this step is the text string and, optionally, compression parameters configured for the system. The server passes the byte sequence to a compression algorithm, which performs data reduction by eliminating representational redundancy. The server receives a compressed binary buffer and may further encode it into text form for compatibility with downstream interfaces. The output is a compressed representation of the prompt sentence that encodes the same information in fewer bytes, thereby reducing the expected number of tokens required by the generative AI model.

Step 14:

The server acquires operation and biometric information to estimate user emotional state.

The server receives additional data from the terminal that describes recent user interactions and, when available, biometric signals. The input to this step is a set of numeric and categorical features such as keystroke intervals, pointer movement statistics, facial expression data, or heart rate measurements. The server normalizes these raw features into standardized numerical vectors by applying scaling, clipping, and encoding operations. The output is a feature vector that is suitable as input for an emotion-estimation model.

Step 15:

The server estimates the user's emotional state using a trained model.

The server feeds the feature vector into an emotion-estimation model implemented as a neural network or other classifier. The input to this step is the normalized feature vector. The server performs matrix multiplications and non-linear transformations as defined by the model's layers and parameters, obtaining output scores for various emotional categories. The server then selects the category with the highest score or computes a weighted combination to represent the emotional state. The output is an estimated emotional state, such as “confused,” “frustrated,” or “confident,” stored as a label and associated confidence values.

Step 16:

The server adjusts wording structure and compression parameters based on the emotional state.

The server reads the estimated emotional state and accesses rule sets that map emotional categories to technical adjustments. The input to this step is the emotional state label and the original prompt sentence or its structured representation. The server may, for example, select a more conservative compression ratio for a confused user or apply more aggressive compression for a confident user. The server can also modify the wording structure by adding clarifying phrases or simplifying complex clauses. These modifications can be applied by transforming an internal representation such as a sentence tree or by inserting and removing predefined textual segments. The output is an adjusted prompt sentence and updated compression parameters tailored to the user's current emotional state.

Step 17:

The server sends the compressed or reconstructed prompt sentence to the generative AI model.

The server constructs a request to the generative AI model including the compressed representation or a reconstructed text derived from it, along with control parameters such as maximum token count and temperature. The input to this step is the adjusted prompt representation and generation parameters. The server serializes this information into an API request and transmits it through a network interface to the model endpoint. The output is a model-invocation message that instructs the generative AI model to generate content based on the optimized prompt.

Step 18:

The server receives generated content from the generative AI model.

The server waits for a response from the generative AI model and, upon receipt, parses the returned data. The input to this step is the response message, which contains a sequence of tokens or a text string representing the model's output. The server decodes the data, converts tokens back into text when necessary, and stores the resulting content in memory. The output is a generated content text that corresponds to the original prompt sentence and is ready for post-processing or direct delivery to the terminal.

Step 19:

The server optionally post-processes the generated content according to template rules.

The server reads the generated text and the template identifier to determine formatting and structuring rules. The input to this step is the raw generated content and the associated template information. The server segments the text into logical sections, adds headings, creates lists, or translates parts of the text if required by the selected blocks (for example, a translation-processing block). The server may also insert metadata markers to help the terminal render the content in a structured layout. The output is a formatted content representation suitable for user display.

Step 20:

The server transmits the final generated content to the terminal.

The server packages the processed content, including any headers, sections, and metadata, into a response object. The input to this step is the formatted content representation. The server serializes the object into a network-friendly format and sends it through the network interface to the terminal associated with the session. The output is a response packet containing the complete generated content for presentation to the user.

Step 21:

The terminal displays the generated content to the user.

The terminal receives the response packet, parses the content fields, and loads them into display structures such as text buffers and layout objects. The input to this step is the formatted content data from the server. The terminal renders headings, paragraphs, lists, and other elements on the display device, possibly applying style rules derived from the template. The output is a visual presentation of the generated content that the user can read, scroll through, and interact with.

Step 22:

The user reviews the generated content and decides whether to refine the prompt.

The user inspects the displayed content, evaluates whether it satisfies the intended purpose, and may choose to modify the original block arrangement if necessary. The input to this step is the visible generated content. The user may navigate back to the block workspace, change parameters (for example, modify the destination city or adjust required detail level), and initiate a new generation cycle. The output is either acceptance of the content or a new set of block edits that, when processed through the preceding steps, lead to a revised prompt sentence and updated generated content.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that generate prompt sentences for generative AI models typically construct prompts as plain, monolithic text directly authored by users or application logic. In such systems, the prompt text is not systematically structured, is not built from reusable functional elements, and is not optimized at the level of information units such as characters or tokens. As a result, these systems suffer from several technical problems in the field of computer technology.

First, when a user attempts to assign a specific expert role to a generative AI model and to specify complex operations such as multi-step translation and explanation, the prompt sentence tends to become long and redundant. Because the underlying communication with the generative AI model is constrained by token or information-unit limits, this redundancy increases the information unit usage rate, leading to higher computational load, longer processing times, and higher usage costs on computing resources.

Second, existing systems usually treat prompt text as opaque text strings and do not explicitly model the internal structure of the prompt. Without a structured representation and a component-assembly mechanism, the system cannot efficiently analyze, reuse, or adapt prompt fragments in response to contextual or performance requirements. This lack of structure prevents effective optimization of prompt content and complicates dynamic control of prompt-processing pipelines.

Third, conventional compression or optimization, when applied at all, is often performed only at the transport layer (for example, HTTP-level compression) and is not integrated into the logical prompt construction process. Such approaches do not measure or manage information units at the level relevant to generative AI processing and therefore cannot systematically reduce token counts while preserving semantic instructions. Consequently, system-level processing efficiency, including storage, transmission, and AI inference, remains suboptimal.

Fourth, existing systems typically do not persist and correlate detailed information about templates, information structures, component-assembly elements, compressed and uncompressed information-unit counts, and AI processing results. Without this correlated historical data, the system cannot dynamically reconfigure subsequent prompt sentences or compression conditions based on empirical performance. This absence of feedback-based adaptation hinders progressive optimization of the overall computer system.

Therefore, there is a need for a computer-implemented system that structurally represents and assembles prompt sentences using a component-assembly language, applies lossless compression in a manner aware of information-unit usage, measures and logs information-unit metrics before and after compression, and adaptively modifies prompt construction and compression parameters based on stored associations between prompt configurations and generative AI processing results. By addressing these technical deficiencies, the invention aims to improve the efficiency and scalability of computer systems that interact with generative AI models.

The specific processing by the specific processing unit 290 of the data processing device 12 in Example 2 is realized by the following means.

The present invention provides a server comprising a processor configured to present an information structure to a user and distribute a template that defines a framework for assigning a role and operation content to a generative information processing apparatus by using the information structure, to generate structural information of a prompt sentence including instruction content for the generative information processing apparatus by analyzing, based on a component-assembly language, a plurality of functional elements input by the user and integrating the functional elements into the template, to generate, as text data, a prompt sentence including a role definition relating to a specialized field, a response policy, and an instruction relating to translation or explanation of target information on the basis of the structural information, to convert the text data into a code sequence and compress the code sequence by a lossless compression scheme to reduce an amount of information units so as to lower an information unit usage rate of the prompt sentence, to measure an amount of information or a number of information units before and after compression and control generation efficiency and processing efficiency of the prompt sentence by adjusting an application method of the component-assembly language or an expression of the prompt sentence based on a measurement result, and to store, in association with one another, the information structure, the template, functional elements based on the component-assembly language, numbers of information units before and after compression, and processing results by the generative information processing apparatus, and dynamically reset a configuration of a subsequent prompt sentence and compression conditions based on stored contents so as to reduce a number of information units of the prompt sentence and improve processing efficiency of the system. This enables a computer system to structurally construct, compress, and adapt prompt sentences for a generative AI model in a manner that reduces information-unit consumption, optimizes resource usage in storage, communication, and inference, and enhances overall system performance through feedback-driven reconfiguration.

The term “information structure” refers to an abstract data framework that organizes and constrains how prompt-related data elements are arranged, combined, and interpreted for constructing prompt sentences for a generative information processing apparatus.

The term “template” refers to a predefined data pattern or schema that specifies a base framework of a prompt sentence, including fixed text segments and insertion points, and that serves as a starting point for assigning roles and operation contents to a generative information processing apparatus.

The term “generative information processing apparatus” refers to a computing system, implemented by hardware and software, that receives a prompt sentence as input and generates output information by performing probabilistic or machine-learned inference, such as a generative AI model.

The term “role” refers to a functional designation assigned to the generative information processing apparatus, indicating a specialized viewpoint, expertise, or behavioral mode, such as acting as an expert in a particular technical or professional domain.

The term “operation content” refers to a description of specific tasks, behaviors, or processing steps that the generative information processing apparatus is instructed to perform in response to a prompt sentence.

The term “component-assembly language” refers to a formal or semi-formal specification language in which a prompt sentence is constructed by selecting and combining modular functional elements that each represent a distinct instruction, behavior, or constraint.

The term “functional element” refers to a unitary component in the component-assembly language that encapsulates a specific function, such as role assignment, translation, explanation, summarization, or formatting, for inclusion in a prompt sentence.

The term “structural information of a prompt sentence” refers to a machine-readable representation, such as a tree or graph, that describes the hierarchical and sequential arrangement of text fragments and functional elements that make up a prompt sentence.

The term “prompt sentence” refers to a machine-processable text string including instructions, constraints, and contextual information that are provided to a generative information processing apparatus to induce a particular type of output.

The term “text data” refers to a sequence of characters encoded in a character set, such as Unicode, that represents human-readable content including the prompt sentence or a portion thereof.

The term “code sequence” refers to a sequence of encoded units, such as bytes or symbols, obtained by encoding text data according to a predetermined encoding scheme for the purpose of storage, transmission, or compression.

The term “lossless compression scheme” refers to a data compression method that reduces the size of a code sequence without discarding information, such that the original sequence can be perfectly reconstructed from the compressed sequence.

The term “information unit” refers to a minimal quantized element used for measuring the size of data, including but not limited to a character, a byte, or a token used by a generative information processing apparatus.

The term “information unit usage rate” refers to a measure representing an amount or density of information units consumed by a prompt sentence relative to a given limit, processing capacity, or reference quantity.

The term “measurement result” refers to a value or set of values derived from measuring quantities such as an amount of information, a number of information units before and after compression, or other prompt-related metrics.

The term “generation efficiency” refers to a performance characteristic that indicates how effectively a system constructs prompt sentences, including aspects such as computational cost, time consumption, and resource utilization.

The term “processing efficiency” refers to a performance characteristic of a system that encompasses how efficiently the system stores, transmits, and processes prompt sentences and responses, including the efficiency of the generative information processing apparatus.

The term “application method of the component-assembly language” refers to a strategy or rule set defining how functional elements expressed in the component-assembly language are selected, combined, ordered, and transformed when constructing a prompt sentence.

The term “expression of the prompt sentence” refers to the specific textual form, including wording, structure, and formatting, in which the instructions and context for the generative information processing apparatus are represented.

The term “role designation element” refers to a functional element in the component-assembly language that specifies a role to be assigned to the generative information processing apparatus, such as a particular field of expertise or perspective.

The term “specialized field” refers to a domain of knowledge or practice requiring specific expertise, such as a scientific, technical, medical, legal, or other professional domain.

The term “translation element” refers to a functional element in the component-assembly language that instructs that content of a prompt sentence be converted between at least two natural languages.

The term “natural language” refers to a human language used for general communication, such as English, Japanese, or any other human language, as opposed to a formal programming or markup language.

The term “preview element” refers to a functional element in the component-assembly language that causes candidate prompt sentences to be generated in advance and presented to a user in a form that allows review and editing.

The term “processing result by the generative information processing apparatus” refers to an output produced by the generative information processing apparatus in response to a prompt sentence, including generated text and associated metadata.

The term “compression conditions” refers to parameters, settings, or rules that govern how a lossless compression scheme is applied to a code sequence, including choices of algorithm, compression level, or segmentation strategy.

The term “configuration of a subsequent prompt sentence” refers to a structure, composition, and selected functional elements of a later prompt sentence that are determined based on previously stored information and performance data.

In one embodiment, a server implements the claimed system as a network-accessible prompt management platform that interacts with a generative AI model. The server comprises a processor, a main memory, a nonvolatile storage device, and a network interface. The processor executes an operating system such as a UNIX-like system, and application software implemented, for example, using a web framework such as a script-based server framework. The nonvolatile storage device stores an information structure repository, a template repository, a component-assembly language specification, a compression module, a prompt/response log, and model interaction logic. A terminal, such as a smartphone, a tablet, or a personal computer, executes a web browser or native application and provides a user interface. A user operates the terminal to interact with the server over a packet-switched network using a protocol such as HTTPS.

The server stores, in the information structure repository, machine-readable definitions of information structures. Each information structure is represented as a data schema, such as a tree of nodes with attributes specifying a role section, instruction slots, and content placeholders. The server associates each information structure with one or more templates. Each template contains base prompt text fragments, markers identifying insertion points for functional elements, and metadata specifying allowable functional elements. The server stores these templates in a relational database or key-value store as structured records including template identifier, base text, insertion point descriptors, and applicable specialized fields.

The server provides to the terminal template metadata via an application programming interface. The terminal renders a list of available templates and displays to the user the base text and configurable sections. The user selects a template and, through the terminal interface, specifies functional elements using a component-assembly language. The component-assembly language is defined by the server as a grammar, for example in a context-free form, and the server stores corresponding production rules and semantic actions. The grammar supports functional elements such as a role designation element, a translation element, an explanation element, a summarization element, and a preview element. Each functional element is associated with a semantic expansion rule that maps the element and its parameters to one or more prompt text fragments and configuration flags.

The server parses, using a parsing module, the component-assembly language expressions received from the terminal. The server may employ a parser generator-based library or a hand-written recursive descent parser to transform the textual component-assembly expressions into an abstract syntax tree. The abstract syntax tree encodes the hierarchical relationship among the functional elements, their parameters, and the insertion points in the template. The server traverses the abstract syntax tree and generates structural information of a prompt sentence in the form of an intermediate representation. This intermediate representation can be, for example, a list of nodes where each node specifies a text fragment identifier, a specialized field role tag, a translation requirement, and associated rendering options.

The server maintains a mapping between nodes of the intermediate representation and concrete text fragments stored in the template repository. When the server receives a fully resolved intermediate representation, the server concatenates the corresponding text fragments according to the structure, inserts user-supplied content at designated placeholders, and applies normalization rules, such as removal of duplicated role definitions or redundant instructions. The resulting text forms the prompt sentence as text data, encoded in a character set such as UTF-8.

In one specific example, the user selects an information structure corresponding to a medical expert role and applies a translation element and an explanation element. Based on the template and the functional elements, the server generates the following prompt sentence:

“You are a medical expert. Please answer patient questions using professional medical knowledge. Translate the following description of the medical condition from English to Japanese, and then explain the condition and recommended next steps in language that is easy for the patient to understand:

‘The patient has been experiencing intermittent chest pain for the last two weeks, especially during exercise, accompanied by shortness of breath and mild dizziness.’”

The server converts the prompt sentence, as text data, into a code sequence by encoding the characters into bytes. The server applies a lossless compression scheme, such as a dictionary-based or entropy-based compression algorithm, to reduce the amount of data. The server computes the compressed representation and calculates the number of information units, such as bytes or model tokens, before and after compression. The server records these quantities in a prompt log along with the information structure identifier, template identifier, functional element identifiers, and timestamp.

The server further converts the prompt sentence into token units to match the internal representation used by the generative AI model. The server uses a tokenizer algorithm that segments the text into subword or wordpiece units based on a precomputed vocabulary and encoding scheme. The server measures the number of tokens used by the prompt sentence, correlates this number with the compression metrics, and updates a persistent store used for optimization. By maintaining this detailed data, the server can compute statistics such as average token count per template, distribution of token savings achieved by particular combinations of functional elements, and time required to process each prompt.

The server provides, as part of its internal logic, a control module that adjusts the application method of the component-assembly language based on the stored measurements. For example, if a particular combination of functional elements consistently produces prompts with high token counts and low compression gains, the server modifies the expansion rules to use shorter but semantically equivalent text fragments, or merges multiple instructions into compact formulations. The server may alter the grammar rules to prefer compressed constructs and may enable or disable specific synonyms based on their token footprint. This adaptation occurs automatically as a programmatic update to the structural information generation process, not as a manual change by the user.

In another embodiment, the server stores, for each template, a set of alternative text fragments for the same semantic role or instruction. The server associates each alternative fragment with a measured token cost and performance indicators such as model output length or latency. When constructing a new prompt sentence, the server selects fragments based on a cost function that assigns higher weight to lower token costs while preserving semantic completeness. This cost-based selection is implemented as an algorithmic decision within the server, using, for example, dynamic programming or greedy optimization. Consequently, the server configures prompt sentences in a manner that systematically reduces information unit usage without requiring user intervention.

The server interacts with a generative AI model hosted either on the same machine or on a remote computing infrastructure. The generative AI model is implemented as a neural network, such as a transformer-based architecture with multiple self-attention layers, feedforward layers, and embedding layers. The model parameters include weight matrices for attention mechanisms, projection matrices for hidden layers, and embedding tables for tokens. During offline training, the model is trained on large corpora of text using stochastic gradient descent or a variant thereof, such as Adam optimization. The model minimizes a loss function, typically a cross-entropy loss between predicted token distributions and target tokens. The training process updates the network weights according to backpropagation and learning rate schedules.

The server communicates with this generative AI model by transmitting the prompt sentence as a sequence of tokens, along with control parameters such as maximum output length and sampling temperature. The server may call a locally hosted inference engine that runs on one or more processors or accelerators, such as graphics processing units or tensor processing units, to perform forward propagation through the trained network weights. Alternatively, the server may send the token sequence to a remote inference endpoint over a network using a structured request. In both cases, the server receives the model output as a sequence of tokens representing the generated response, decodes the tokens into characters, and reconstructs the response text.

The server compresses the model output using the same or a different lossless compression scheme and records token counts and compression metrics for the response. By doing so, the server reduces communication overhead between the server and the terminal and optimizes storage for archiving responses. The server correlates the response characteristics, such as length, response time, and any quality indicators, with the prompt configuration that produced them. This correlation allows the server to refine subsequent prompt construction in a feedback-driven manner, leading to improved technical performance of the overall system. The terminal receives compressed or uncompressed prompts and responses from the server and performs decompression when necessary. The terminal executes a decoding algorithm that inverts the server's compression scheme and reconstructs the original text. The terminal presents the prompts for preview and editing and displays the model responses in a user interface. The user can initiate new queries, modify functional elements in the component-assembly language, and request that the server regenerate prompts. The user does not manually optimize token usage; instead, the server handles such optimization through internal algorithms based on the stored structural and measurement data.

In one embodiment, the server operates in an environment where network bandwidth is limited or costly, such as a wireless communication network. Because the server compresses prompt sentences and generated responses and reduces token counts through structural optimization, the system reduces the volume of data transferred over the network. This reduction leads to lower communication latency and lower energy consumption by network hardware. The system therefore yields a concrete improvement in computer network operation, beyond merely automating human text composition.

In another embodiment, the server uses the stored history of prompt configurations and model outputs to train an auxiliary model that predicts the token cost and effectiveness of potential functional element combinations. The server implements this auxiliary model as a smaller neural network or as a rule-based engine. When the user defines or modifies functional elements through the component-assembly language, the server consults the auxiliary model to anticipate token costs and to propose alternative configurations with lower expected cost. This predictive selection process is a technical optimization that changes how the computer constructs and encodes prompts at run time.

The server thereby improves computational efficiency by reducing the number of information units that the generative AI model must process for a given task. Because transformer-based generative models often have computational complexity that scales at least quadratically with sequence length in their attention mechanisms, any reduction in token count yields a direct reduction in the number of floating-point operations performed during inference. As a result, the server contributes to lower processor load, reduced inference latency, and improved throughput of model requests.

The server further improves data management by maintaining structured logs that associate information structures, templates, functional elements, compression metrics, and model outputs. Unlike conventional logging of raw prompt text, this structured logging allows the server to efficiently query and analyze prompt configurations at a fine-grained level. The server can, for example, identify which templates yield the highest token efficiency or which functional elements consistently produce unnecessary redundancy. This capability leads to algorithmic adjustments in the component-assembly language and fragment selection rules, providing a self-optimizing behavior in the computer system.

The system is not limited to a single specialized field. In a variant embodiment, the server stores templates and information structures for legal analysis, programming assistance, or technical documentation generation. The server applies the same structural construction, compression, and optimization techniques across these fields. The technical benefits remain, because the underlying computer operations, parsing a component-assembly language, generating intermediate structures, encoding and compressing data, and measuring token usage, are field-agnostic and directly tied to the digital representation and processing of data. In yet another embodiment, the server modifies compression conditions dynamically. The server may adapt compression parameters such as compression level or block size based on real-time measurements of processing load and network conditions. When network congestion is detected, the server may increase compression aggressiveness at the cost of higher CPU usage, whereas in low-load conditions it may choose faster but less compact compression. These dynamic adjustments are computed by the server's control module using threshold rules or optimization algorithms. This behavior demonstrates a direct interaction between the prompt processing logic and the operation of the underlying computing platform.

The server implements all of these functions using software modules executed by the processor, interfacing with the memory, storage, and network interface according to standard bus and I/O protocols. The modules are arranged such that the component-assembly parsing, structural prompt generation, compression, measurement, and interaction with the generative AI model form a coherent processing pipeline that is executed for each prompt-response transaction. The pipeline is designed to minimize redundant operations and to cache intermediate results where appropriate, thereby contributing to improved processing speed and reduced resource consumption.

Through these concrete arrangements, structured representation of prompt sentences using a component-assembly language, algorithmic optimization of token and information unit usage, integration of lossless compression at the logical prompt level, and feedback-driven reconfiguration of subsequent prompt construction, the server improves the functioning of computer systems that interact with a generative AI model. The improvement is not limited to automating human prompt drafting; instead, the system modifies how the computer represents, stores, transmits, and processes text data at a low level, yielding measurable enhancements in processing efficiency, communication load, and resource utilization.

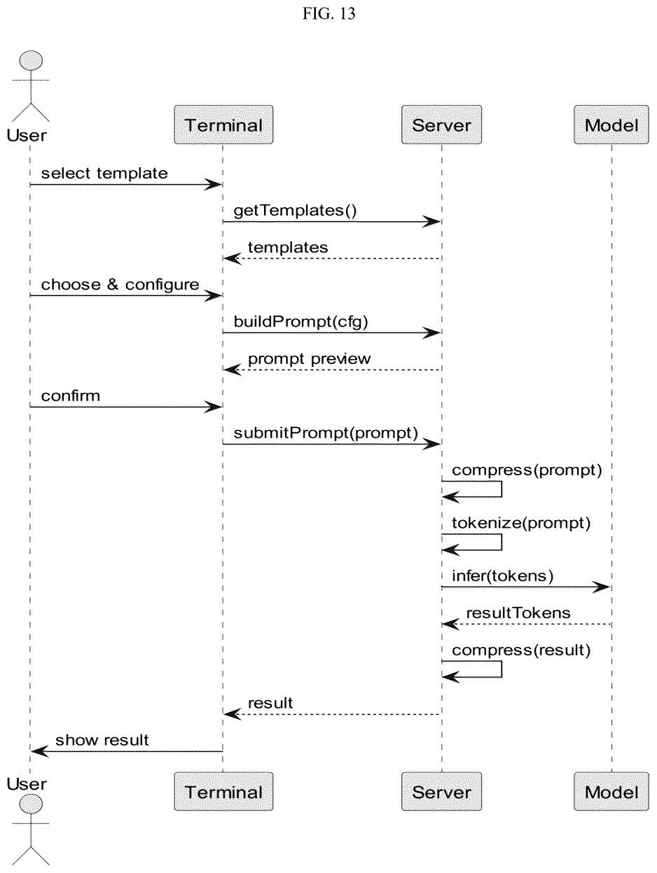

The following describes the processing flow using FIG. 13.

Step 1:

The terminal displays available information structures and templates to the user.

The terminal sends a request to the server as input, the request including a command to obtain a list of templates and information structures.

The server receives the request and queries a storage device as input, the storage device storing records of information structures and associated templates, and the server outputs a structured list including identifiers, names, and brief descriptions.

The terminal receives the structured list as input, converts the data into user interface components, and outputs a screen that shows selectable entries such as “medical expert,” “legal advisor,” or “technical support” to the user.

The user observes the screen and selects one template corresponding to a desired role, and the terminal outputs a selection command that identifies the chosen template.

Step 2:

The terminal sends a template detail request to the server based on the user's selection.

The server receives the template identifier as input, accesses a template repository as input, and retrieves detailed template data including base prompt fragments, insertion point descriptors, and allowable functional elements as output.

The server performs data processing by assembling these fragments into a structured record that contains a base prompt text, a list of slots where additional instructions can be inserted, and metadata describing specialized fields and constraints.

The terminal receives the structured template data as input and outputs a configuration screen that shows the base prompt sentence skeleton, labels for insertion points, and available categories of functional elements.

Step 3:

The user specifies functional elements using a component-assembly language through the terminal interface.

The terminal receives user actions as input, such as selecting a role designation, adding a translation instruction, or adding an explanation instruction, and the terminal converts these actions into one or more component-assembly language expressions as output.

The terminal sends the component-assembly language expressions and the template identifier to the server as input in a structured request.

The server receives the request and outputs the raw component-assembly code to a parsing module for further processing.

Step 4:

The server parses the component-assembly language and generates structural information of a prompt sentence.

The server uses the component-assembly language expressions and template data as input to a parser implemented, for example, using a context-free grammar.

The server performs syntactic analysis to generate an abstract syntax tree as output, where each node represents a functional element and its parameters.

The server then performs semantic analysis by matching each node in the abstract syntax tree with predefined semantic rules stored in a rule repository as input, and outputs an intermediate representation that specifies the order, type, and parameterization of text fragments and instructions to be inserted into the prompt sentence.

The server thus conducts data processing that transforms user-level component expressions into a machine-readable structure describing the intended prompt configuration.

Step 5:

The server constructs a concrete prompt sentence from the structural information.

The server receives the intermediate representation and the associated template fragments as input.

The server performs a sequence of data operations that include:
resolving each node in the intermediate representation to one or more text fragments;
inserting user-provided parameters, such as language pairs or subject descriptions, into designated placeholders;
concatenating fragments in the order defined by the intermediate representation; and
normalizing whitespace and removing redundant instructions.

The server outputs a finalized prompt sentence as text data.

The terminal may request a preview, and the server sends the generated prompt sentence as input to the terminal, which outputs it to the user on a preview screen for confirmation.

Step 6:

The user confirms the prompt sentence and requests submission to the generative AI model. The terminal receives the user's confirmation as input and outputs a submission command that includes the finalized prompt sentence or its identifier.

The server receives this command as input, retrieves the corresponding prompt sentence from storage if needed, and outputs the prompt sentence to a compression module for further processing.

Step 7:

The server compresses the prompt sentence to reduce information unit usage.

The server receives the prompt sentence as text data input and converts it into a code sequence, such as a sequence of bytes encoded in UTF-8.

The server applies a lossless compression algorithm to the code sequence, performing data operations such as dictionary building, pattern matching, and entropy coding, and outputs a compressed code sequence.

The server calculates the number of information units, such as bytes or tokens, before and after compression as output metrics.

The server stores, as output, a record that associates the prompt identifier, the uncompressed length, the compressed length, and any token counts, and returns an indication to the terminal that a compressed prompt version is available.

Step 8:

The server converts the prompt sentence into tokens for the generative AI model and manages token-related metrics.

The server receives the finalized prompt sentence as input and applies a tokenizer algorithm that maps substrings to token identifiers.

The server performs data processing by scanning the character sequence, matching subword units against a model-specific vocabulary, and generating a token sequence as output.

The server counts the number of tokens and associates the count with the stored metrics for the corresponding prompt.

The server uses these values as input to an optimization module that evaluates whether the prompt configuration meets internal limits or should be adjusted in subsequent operations.

Step 9:

The server sends the prompt sentence to the generative AI model and obtains a response.

The server uses the token sequence and configuration parameters, such as maximum output tokens and sampling settings, as input to the generative AI model interface.

The server transmits these inputs to a neural network-based generative AI model implemented, for example, as a transformer network with multiple attention layers and learned weight matrices.

The generative AI model performs forward propagation over its layers, computing attention scores, weighted sums, and nonlinear transformations of hidden states, and outputs a sequence of predicted tokens representing the response.

The server receives this token sequence as input, decodes the tokens into text using the model's vocabulary, and outputs the generated response text.

Step 10:

The server compresses and logs the model response.

The server receives the generated response text as input and converts it into a code sequence using the same character encoding as for the prompt.

The server performs lossless compression on the response code sequence, yielding a compressed response as output.

The server calculates and stores metrics such as uncompressed length, compressed length, response token count, response generation time, and an association with the originating prompt identifier.

The server records these metrics and associations in a log storage as output, which can be used as input to later optimization processes that adjust future prompt configurations and compression conditions.

Step 11:

The server transmits the response to the terminal.

The server receives a delivery request from the terminal as input, identifying the response associated with a particular prompt or conversation.

The server fetches either the compressed or uncompressed response from storage as input, depending on configuration, and outputs the chosen format to the terminal via a network connection.

The terminal receives the response as input, decompresses it if necessary by applying a decompression algorithm that inverts the server's compression procedure, and outputs the reconstructed response text.

Step 12:

The terminal displays the response to the user and supports iterative refinement.

The terminal receives the reconstructed response text as input and performs data preparation operations such as line wrapping, segmentation into paragraphs, and formatting for display. The terminal outputs the formatted response on the screen, where the user can read the generated explanation, translation, or other expert content.

The user may provide further input by modifying functional elements or posing follow-up questions, and the terminal converts such input into new component-assembly language expressions as output, which are sent to the server.

The server then uses these new inputs as the basis for another iteration of the prompt construction, compression, and generative AI model interaction flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented interaction systems that generate prompt sentences for generative AI models suffer from several technical limitations at the level of core information processing. First, such systems typically construct prompts as monolithic text strings authored manually or with simple templates, without using a structured, machine-interpretable representation. As a result, the server cannot programmatically analyze and reconfigure the prompt structure, and cannot automatically adapt the composition or detail level of the prompt to meet dynamic resource constraints such as token budgets of the generative AI model. This leads to inefficient token usage, unnecessary network traffic, and suboptimal utilization of computational resources in the AI backend.

Second, known systems generally treat emotion-related information, if considered at all, as an auxiliary UI feature rather than as a first-class control signal in the core text-processing pipeline. Emotion detection, when present, is not integrated into the server-side logic that governs prompt construction, compression, and post-processing. Consequently, the server is unable to adjust compression strength, content structure, or textual style according to a current cognitive state of the user. This causes a mismatch between the complexity of the generated prompt or response and the user's cognitive capacity at that time, leading to increased user error, unnecessary repetitions, and degraded throughput in human-machine interaction.

Third, existing prompt-generation flows often implement length control using crude heuristics such as hard character limits or fixed truncation. These approaches discard information blindly and do not exploit natural language processing analysis. Because the server does not apply linguistic operations such as syntactic analysis and semantic-preserving summarization, the resulting compressed prompts may lose important constraints, context, or role instructions, which degrades the accuracy and stability of the generative AI model. Furthermore, these systems cannot selectively vary compression strategies based on real-time signals (for example, emotion state or domain type), and therefore cannot optimize both model performance and user experience in a principled manner.

Fourth, many systems deliver the model's raw response directly to the terminal without structured, emotion-aware server-side post-processing. In such architectures, the server does not systematically summarize or restructure the generative AI output according to the user's current emotion state. This absence of adaptive post-processing leads to responses that are either overly verbose or insufficiently detailed, imposing unnecessary cognitive load on the user and yielding inefficient use of display and communication resources.

In view of these issues, there is a need for an improved computer-implemented system and server-side processing architecture that: (i) manages prompt generation using structured, block-based representations, (ii) integrates emotion recognition results into the core decision logic for prompt composition and compression, (iii) performs linguistically informed compression to reduce token usage while preserving semantic constraints, and (iv) applies emotion-aware post-processing to the model's response. Such an architecture should improve processing efficiency and resource utilization at the server and generative AI model, while simultaneously reducing cognitive load and interaction latency from the user's perspective.

The specific processing by the specific processing unit 290 of the data processing device 12 in Application Example 2 is realized by the following means.

The present invention provides a server comprising a processor configured to distribute, to a user terminal, structure information for instruction generation including templates and structural elements; to generate, by using a language representation that visually and structurally combines the structural elements, a prompt sentence for instructing a generative information processing model based on structure information selected by a user and target information input by the user; to perform a compression processing using natural language processing on the generated prompt sentence and the target information in order to reduce a number of tokens; to identify an emotion state of the user by using an emotion recognition model that estimates the emotion state based on at least one of image information, audio information, and character information; to dynamically modify, according to the identified emotion state, at least one of a composition, a level of detail, a compression ratio, and a style of the prompt sentence so as to control a cognitive load of the user and a token usage rate of the generative information processing model; to generate a final prompt sentence that reflects the emotion state and the compression processing in accordance with an input and output format of the generative information processing model and to transmit the final prompt sentence to the generative information processing model; and to perform post-processing on response information obtained from the generative information processing model by at least one of summarizing, structuring, and rearranging the response information according to the emotion state of the user and to provide a result of the post-processing to the user terminal. This enables the server to implement an emotion-adaptive, token-efficient text-processing pipeline in which prompt generation, compression, and response formatting are controlled as core computational operations, thereby improving utilization efficiency of the generative AI model, reducing communication and processing overhead, and lowering cognitive load on the user during interaction.

The term “processor” refers to a hardware or virtual computation unit, such as a central processing unit or execution core, that executes machine-readable instructions to perform the functions described in the present specification.

The term “user terminal” refers to an information processing apparatus operated by a user, such as a portable device, stationary device, or display device, that communicates with the server and presents information to the user.

The term “structure information” refers to data defining a framework for generating instruction text, including templates, structural elements, and their relationships, which can be programmatically combined to construct a prompt sentence.

The term “template” refers to a pre-defined pattern or framework including fixed text and variable placeholders, which serves as a base for constructing a prompt sentence for a generative information processing model.

The term “structural element” refers to a discrete component of structure information, such as a block or field, that represents a specific functional part of a prompt sentence, including role information, task information, constraint information, or output format information.

The term “instruction generation” refers to a process of constructing text or structured data that directs a computing model to perform a particular operation or sequence of operations.

The term “prompt sentence” refers to a text string or sequence of tokens that contains instructions, constraints, or context for causing a generative information processing model to perform a specified processing.

The term “generative information processing model” refers to a model implemented by software and hardware, such as a probabilistic model or neural network, that generates information including text or structured data in response to an input prompt sentence.

The term “language representation that visually and structurally combines the structural elements” refers to a representation scheme in which structural elements are arranged, connected, or edited in a visual manner, such as by block-based or component-based editing, and are converted into a textual prompt sentence.

The term “target information” refers to domain-specific data or context supplied by the user, such as task data, resource data, or description data, that is to be analyzed or processed by the generative information processing model.

The term “compression processing” refers to a processing operation that reduces a size of text data, such as a number of characters or tokens, while attempting to preserve essential meaning or constraints contained in the original text.

The term “natural language processing” refers to a class of computational techniques that analyze, interpret, transform, or generate human language text, including tokenization, morphological analysis, syntactic analysis, semantic analysis, and summarization.

The term “number of tokens” refers to a quantity of basic text units, such as word units or subword units, into which a prompt sentence or other text is divided for processing by the generative information processing model.

The term “emotion state” refers to a psychological condition of the user, such as tension, anxiety, stability, happiness, or interest, estimated on the basis of observable signals.

The term “emotion recognition model” refers to a computation model, such as a statistical model or machine learning model, configured to estimate an emotion state of the user from input data including image information, audio information, or character information.

The term “image information” refers to visual data representing at least part of the user or surroundings, such as a still image or moving image captured by an imaging device.

The term “audio information” refers to sound data including at least a voice of the user or ambient sound, captured by a sound acquisition device.

The term “character information” refers to textual data associated with the user, including input sentences, messages, or other symbol sequences produced or selected by the user.

The term “composition of the prompt sentence” refers to a structural arrangement of elements within the prompt sentence, including ordering, grouping, and inclusion or exclusion of sections such as role description, task description, constraints, and data description.

The term “level of detail” refers to a degree of specificity or granularity of content in the prompt sentence, including an amount of explanatory text, examples, and fine-grained constraints.

The term “compression ratio” refers to a measure indicating a degree of reduction applied to text, such as a ratio of token count after compression to token count before compression.

The term “style of the prompt sentence” refers to linguistic characteristics of the prompt sentence, including tone, politeness level, formality, and sentence structure pattern.

The term “cognitive load” refers to an amount of mental processing effort required from the user to understand and act upon information provided by the system, including prompt sentences and responses.

The term “token usage rate” refers to an amount or proportion of tokens consumed by prompt sentences and responses when interacting with the generative information processing model, relative to an available token budget or processing capacity.

The term “final prompt sentence” refers to a prompt sentence that has been generated and modified by the processor, including application of compression processing and emotion-based adjustments, and is ready to be transmitted to the generative information processing model.

The term “input and output format of the generative information processing model” refers to structural and syntactic specifications required by the generative information processing model for receiving prompts and returning responses, such as message types, fields, or encoding schemes.

The term “response information” refers to output data generated by the generative information processing model in reply to a prompt sentence, including textual explanations, lists, structured records, or other generated content.

The term “post-processing” refers to a processing operation applied by the processor to response information, such as summarizing, structuring, rearranging, filtering, or reformatting the information prior to providing it to the user terminal.

In one or more embodiments, a server cooperates with one or more terminals operated by a user to generate, transmit, and refine a prompt sentence for a generative AI model while adapting processing to an emotion state of the user and reducing token usage. The following description illustrates exemplary embodiments that support and enable the claimed invention, but the invention is not limited to these particular configurations.

### A. Overall Hardware and Software Configuration

A server includes at least one processor, a main memory, a nonvolatile storage, a network interface, and an I/O interface. The processor executes machine-readable instructions stored in the memory to implement the functions described below. The server runs, for example, an operating system such as a general-purpose server OS and a web application framework such as a Python-based web framework. The server further uses a relational database management system, such as a SQL-compatible database, to store templates, structural elements, logs, and user session data.

A terminal includes at least one processor, a memory, a display device such as a liquid crystal display or head-mounted display, a sound output device such as a speaker, an imaging device such as a camera, a sound input device such as a microphone, and a communication unit such as a wireless transceiver. The terminal executes an application, for example, a browser-based web application implemented in JavaScript or a native mobile or wearable application, that communicates with the server over a network such as the Internet.

The server and the terminal communicate using a protocol such as HTTPS. The server exposes application programming interfaces (APIs) for downloading templates and structural elements, uploading user-generated structures and text, acquiring emotion recognition results, and sending and receiving data for interaction with a generative AI model. The generative AI model is hosted on a separate computation platform or on the same server, and provides an interface that accepts a prompt sentence and returns generated text.

### B. Structure Information and Block-Based Instruction Generation

The server stores, in the database, structure information for instruction generation. The structure information includes:

(1) Templates: Each template defines a base pattern for a prompt sentence, including fixed text portions and placeholders. For example, a template for security analysis may include text such as:

“You are a data security expert. Analyze the following system description and logs, identify potential risks, and propose concrete mitigation measures.”

(2) Structural elements: The structural elements represent functional units, such as a role designation element, a processing content designation element, a constraint condition designation element, and an output format designation element. Each element is described as a record containing an identifier, a human-readable label, a parameter schema, and rules indicating how the element is combined with other elements.

The server distributes the structure information to the terminal. The server converts templates and structural elements into a format suitable for a visual editor, for example, a hierarchical or graph-based structure describing available blocks and the relationships between them. By using this structure information, the terminal is able to render a block-based editor without hard-coding the logic into the terminal application.

The terminal uses the distributed structure information to construct a visual editing environment. The terminal displays block icons corresponding to the structural elements and allows the user to drag and drop, connect, and configure these blocks. The terminal internally represents the configuration as a data structure, for example, a tree or graph in memory, in which each node corresponds to a structural element instance and stores attribute values input by the user.

The terminal converts this structured representation into a textual prompt sentence by traversing the structure and concatenating phrase segments associated with each structural element. The traversal applies combination rules supplied by the server, such as ordering constraints and syntactic patterns. This block-based generation differs from manual text entry because the structure is explicitly represented and thus can be programmatically analyzed, rearranged, and compressed by the server.

As a concrete example, the user selects a template and constructs a prompt sentence by arranging blocks. The resulting text may be:

“You are a medical data security expert. Analyze the following medical data and access logs, evaluate the security risk, and propose specific mitigation measures.”

In another example, the user constructs an instruction for technical advice:

“You are an AI technology expert. Explain the latest trends in generative AI, including key model architectures and practical business use cases, in a clear but technically accurate way.”

### C. Emotion Recognition and Emotion State Representation

The terminal acquires raw emotion-related signals using hardware sensors. The camera captures frames of the user's face at a predetermined frame rate. The microphone records short audio segments containing the user's speech. The terminal also collects text typed or selected by the user.

The terminal pre-processes these signals into feature representations. For image data, the terminal may perform operations such as resizing, normalization, and face detection, and may send either feature vectors or compressed images to an emotion recognition module. For audio data, the terminal may compute acoustic features such as Mel-frequency cepstral coefficients, energy, and pitch contours. For text data, the terminal may compute simple linguistic features such as sentiment scores using a local model or may send the raw text to the server for further analysis.

The server or an associated emotion recognition module implements an emotion recognition model. In one embodiment, the emotion recognition model comprises a convolutional neural network for image inputs, a recurrent or transformer-based network for audio inputs, and a text encoder for character information, whose outputs are combined by a fusion network. The fusion network outputs a vector of emotion probabilities for categories such as “tension,” “anxiety,” “stability,” “joy,” and “high interest.”

The server stores the emotion state as a data structure containing a discrete label and continuous scores. The server uses an emotion state history for each session to smooth transient fluctuations, for example, by applying a moving average to the probabilities. This emotion representation is then used to control steps of prompt construction, compression, and response post-processing.

### D. Natural Language Processing and Compression Processing

The server performs natural language processing on the prompt sentence and associated target information. The server uses modules such as a tokenizer, a part-of-speech tagger, a dependency parser, and a summarization component. These modules may be implemented by neural networks or statistical models trained in advance on large corpora.

The server converts the prompt sentence into a sequence of tokens and a syntactic structure, for example, a dependency tree. The server identifies redundant text portions based on syntactic roles and semantic similarity, such as adjective chains that do not affect the core constraint, repeated phrases, and unnecessary meta explanations. The server then rewrites the prompt sentence by removing or merging these redundant segments while preserving essential content, including role definitions, tasks, constraints, and data descriptions.

The server also applies summarization to long sections of target information, such as logs or descriptions. The summarization component may be a transformer-based encoder-decoder network trained with a loss function that preserves critical entities and relations. The server may specify a target length in tokens and adjust this target based on the emotion state.

The server further estimates a token count for the generative AI model's tokenizer. The server uses a tokenizer library corresponding to the generative AI model to simulate tokenization and count the tokens. The server iteratively adjusts compression operations until the token count falls within a predefined budget determined by model configuration and resource constraints.

### E. Emotion-Adaptive Control of Composition, Detail, and Compression

The server uses the emotion state to modify the composition, level of detail, compression ratio, and style of the prompt sentence. The server stores rules or parameters defining the relationship between emotion and text properties. For example:
When the emotion state indicates tension or anxiety, the server increases a compression strength parameter and sets a simpler composition pattern. The server reduces nested clauses and converts long explanations into short imperative or bullet-style instructions. This reduces cognitive load on the user and reduces the number of tokens sent to the generative AI model.
When the emotion state indicates stability or high interest, the server decreases compression strength and permits more detailed descriptions and multiple perspectives. The server may add explanatory sentences and explicit rationales for constraints, thereby providing richer context to the generative AI model and potentially improving the quality of generated output.
When the emotion state indicates frustration or negative sentiment, the server switches to a more empathetic style by inserting short supportive phrases and avoiding abrupt phrasing.

This emotion-adaptive control is implemented as deterministic logic and parameter updates applied to the text processing pipeline. The server retrieves the current emotion state, updates a set of control parameters stored in memory, and then applies these parameters when executing the natural language processing and text generation modules. The result is that the same underlying template and user data can be transformed into different prompt sentences optimized both for machine resource usage and for human comprehension.

### F. Interaction with the Generative AI Model

The server constructs a final prompt sentence by combining the compressed and emotion-adapted prompt text with the summarized target information and, if applicable, previous interaction context. The server packages this information according to an input format required by the generative AI model. For example, the server may create a structure containing a “system” message specifying the role, a “user” message containing the task and data, and optional metadata.

The generative AI model is implemented as a neural network architecture such as a multi-layer transformer configured for autoregressive text generation. The model has been trained on a large corpus of text using an objective such as next-token prediction. During training, a loss function such as cross-entropy is minimized with respect to model parameters using an optimization algorithm such as stochastic gradient descent with adaptive learning rate. The model processes token sequences by embedding tokens into vectors, passing them through multiple self-attention and feed-forward layers, and outputting probability distributions over possible next tokens.

During inference, the server sends the tokenized prompt sentence to the generative AI model and receives a sequence of output tokens. The model uses decoding strategies such as greedy decoding or sampling with a temperature parameter. The server converts the output tokens back into text and obtains response information, which may include explanations, lists, or structured text segments.

### G. Post-Processing of Response Information

The server applies post-processing to the response information before transmitting it to the terminal. The server may parse the generated text using the same natural language processing modules used for prompt processing. The server identifies sections, bullet lists, and key entities. The server then modifies the structure and detail level based on the emotion state:
For a user in a tense or anxious state, the server produces a short list of prioritized actions without extensive background. For example, the server may extract three main mitigation steps from a longer response and present them first.
For a user in a stable or highly interested state, the server retains detailed explanations and may insert cross-references or additional context.

By operating at the level of linguistic structure rather than simple truncation, the server avoids losing essential constraints or reasoning steps. Moreover, because the server selectively forwards only the processed response text to the terminal, network traffic and display resource usage are reduced.

### H. Technical Effects and Improvement of Computer Technology

The described system improves computer technology in several respects beyond mere automation of human tasks.

First, the use of structured, block-based prompt construction combined with server-side linguistic compression reduces token usage when interacting with the generative AI model. This directly decreases data volume transmitted over the network and reduces computational load on the generative AI model, resulting in lower latency and improved throughput for many users. The explicit token-count feedback loop and iterative compression yield a more precise control of resource usage than human editing or static length limits.

Second, the integration of emotion recognition into the core text-processing pipeline enables dynamic adjustment of compression, composition, and style parameters. This is not simply replacing human judgment; instead, it leverages a combination of sensor-based feature extraction and learned emotion classification to generate machine-controllable signals that are used to drive algorithmic decisions within the server. As a result, the system can reduce cognitive overload for users under stress, thereby decreasing repeated queries and correction cycles. This reduction in repetition leads to fewer round-trips to the generative AI model and consequently reduces overall processing time and communication overhead.

Third, the linguistic compression process uses syntactic and semantic analysis to selectively remove redundancy. This is different from a generic truncation because the server preserves key role declarations, task specifications, and constraint expressions, which are critical for the generative AI model's behavior. By maintaining these essential elements while reducing nonessential modifiers and verbose examples, the system maintains or improves the correctness of model responses even with fewer tokens. This improves computational efficiency of the model without degrading functional accuracy.

Fourth, the described neural network architectures for emotion recognition and generative output, together with their training methods, define concrete algorithmic structures. The emotion recognition model uses dedicated feature extractors and a fusion network, trained using supervised labels and a loss function such as cross-entropy. The generative AI model uses a transformer architecture trained using sequence modeling objectives. These models process structured feature vectors and token embeddings in ways that would not be feasible with manual human processing, and the system's design explicitly exploits these capabilities to alter data flows, not merely to replace a human evaluator.

Fifth, the combined control of prompt length, structure, and emotion-based presentation leads to lower error rates and higher consistency in responses. Because the server maintains a structured representation of both the prompt sentence and the response, the server can guarantee that specific syntactic slots, such as the section listing required actions, remain present and clear, which reduces misunderstandings and misinterpretations on both the model and user sides.

### I. Exemplary Use Cases

In one example, the user operates a terminal to inquire about security risks. The user constructs a prompt sentence such as:

“You are a medical data security expert. Analyze the following medical data and access logs, evaluate the security risk, and propose specific mitigation measures.”

The server receives this prompt sentence and associated data. The emotion recognition model detects that the user is anxious. The server applies stronger compression to remove lengthy background paragraphs, retains the essential description of system components and access logs, and constructs a final prompt sentence with reduced token count. The generative AI model returns a detailed risk analysis. The server then post-processes this analysis to generate a concise, prioritized list of countermeasures which is displayed on the terminal.

In another example, the user requests technical advice on AI trends and constructs a prompt sentence such as:

“You are an AI technology expert. Explain the latest trends in generative AI, including key model architectures and practical business use cases, in a clear but technically accurate way.”

The emotion recognition model determines that the user's emotion state indicates high interest and low stress. The server reduces compression, preserves detailed explanations and examples, and allows the generative AI model to provide a longer response. The server structures this response with headings and bullet points and supplies the fully detailed information to the terminal.

### J. Variations and Alternative Embodiments

The server may use different natural language processing libraries, different tokenization schemes, or different generative AI architectures, such as encoder-decoder models or mixtures of experts, as long as the server maintains the essential characteristics of structured prompt generation, emotion-adaptive compression, and emotion-aware post-processing. The terminal may be implemented as a smartphone, a tablet, a head-mounted display, or a desktop computer. The generative AI model may be hosted on a separate computation cluster or cloud platform.

The emotion recognition model may be trained on different sets of emotion categories or may produce multi-dimensional continuous scores rather than discrete labels. The control rules mapping emotion states to compression and style parameters may be defined by expert tuning or learned using reinforcement learning based on user interaction metrics.

In all such variations, the server, the terminal, and the generative AI model cooperate to implement a specialized data processing pipeline that modifies data structures, tokenization patterns, and communication flows in a manner tailored to the generative AI model's characteristics and the user's emotion state, thereby improving computational efficiency, resource management, and user comprehension.

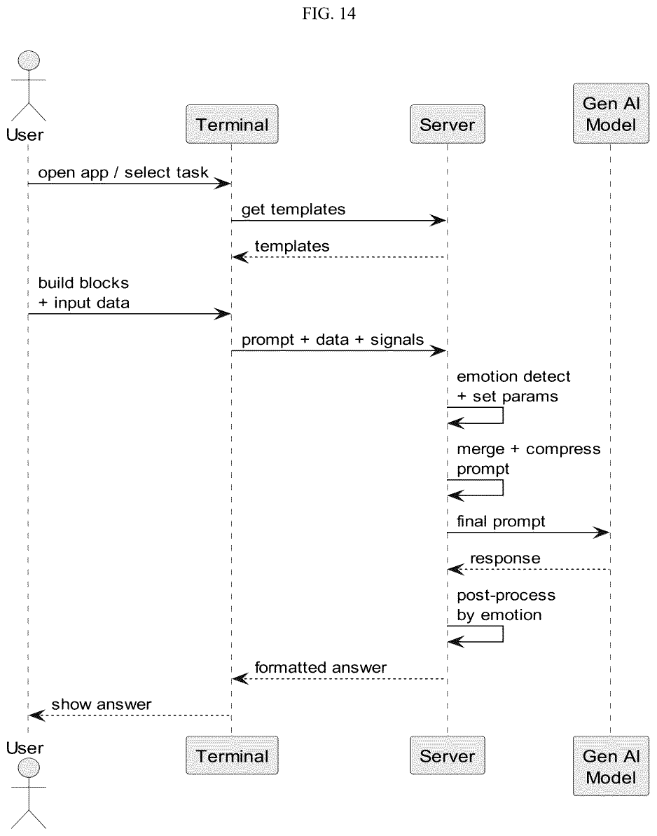

The following describes the processing flow using FIG. 14.

Step 1:

Server initializes configuration and loads structure information.

Server reads, as input, definition data for templates and structural elements from a database.

Server loads, into memory, records that describe each template (fixed phrases, placeholders, applicable domains) and each structural element (role, task, constraint, output format, parameters).

Server constructs internal data structures, such as hash maps and trees, that map template identifiers to their constituent blocks and combination rules.

Server outputs a ready-to-serve catalog of templates and structural elements that can be sent to a terminal upon request.

Step 2:

Terminal requests templates and structural elements.

Terminal takes, as input, a request trigger (for example, app start or user login) and the current user identifier.

Terminal sends a network request to the server asking for available templates and structural elements associated with the user's profile or domain.

Terminal outputs a request message containing the user identifier and desired domain (for example, “security analysis,” “technical advice”) to the server.

Step 3:

Server provides structure information to the terminal.

Server takes, as input, the request message from the terminal.

Server queries the database for matching templates and structural elements, converts them into a transport format (for example, JSON arrays and objects), and attaches metadata such as language options and version numbers.

Server outputs a response message containing the structure information and sends it back to the terminal.

Step 4:

Terminal renders a block-based editor.

Terminal receives, as input, the structure information from the server.

Terminal parses the templates and structural elements and constructs in-memory representations (for example, JavaScript objects or native structs) for each block type.

Terminal generates a graphical user interface that displays blocks for roles, tasks, constraints, and output formats, and enables drag-and-drop, connection, and parameter editing using the display, touch input, and pointer devices.

Terminal outputs a visual editing screen that the user can operate to build a prompt sentence.

Step 5:

User selects a template and arranges blocks.

User takes, as input, the visual block palette presented on the terminal.

User selects a template (for example, “Security risk evaluation”) and drags blocks such as “Role: expert,” “Task: analyze,” “Constraint: short answer,” and “Output: bullet list” into a composition area.

User configures parameters by typing text (for example, “medical data security expert,” “evaluate security risk,” “propose specific mitigation measures”).

User outputs a configured structure graph, implicitly represented within the terminal's internal data model.

Step 6:

Terminal builds a structured representation of the prompt.

Terminal receives, as input, the user's block arrangement and parameter values.

Terminal traverses the GUI elements, constructs a logical graph or tree (for example, nodes for blocks and edges for connections), and serializes this structure into a machine-readable representation such as a nested object with fields for type, parameters, and children.

Terminal outputs a structured representation (for example, a tree of structural elements) that reflects the intended prompt composition.

Step 7:

Terminal converts the structure into a raw prompt sentence.

Terminal takes, as input, the structured representation.

Terminal executes a traversal algorithm that visits nodes in a defined order, concatenates associated phrase templates with parameter values, and inserts connecting words or punctuation according to combination rules.

Terminal thereby generates a raw prompt sentence, for example:

“You are a medical data security expert. Analyze the following medical data and access logs, evaluate the security risk, and propose specific mitigation measures.”

Terminal outputs this raw prompt sentence and attaches it to the structured representation.

Step 8:

Terminal collects target information from the user.

Terminal presents, as input to the user, form fields and file upload controls for domain data.

User types or pastes data such as anonymized patient records, system architecture descriptions, access logs, or business constraints, and optionally uploads files.

Terminal validates the input format, normalizes text encoding, and stores the target information in local memory.

Terminal outputs a dataset that includes the raw prompt sentence and the associated target information.

Step 9:

Terminal captures emotion-related signals.

Terminal takes, as input, sensor streams from the camera, microphone, and text input subsystem.

Terminal periodically captures video frames of the user's face, records short audio segments of speech, and collects text messages and typing speed metrics.

Terminal pre-processes images (for example, crops and resizes faces), extracts audio features (for example, spectral features), and aggregates recent text.

Terminal outputs a bundle of emotion-related data ready to be sent to an emotion recognition module.

Step 10:

Terminal transmits prompt, target information, and emotion data to the server.

Terminal receives, as input, the user's command to proceed (for example, pressing a “Send” or “Analyze” button).

Terminal packages the raw prompt sentence, the structured representation, the target information, and the emotion-related data into a request payload.

Terminal sends this payload to the server via a secure channel.

Terminal outputs a network request containing all necessary data for server-side processing.

Step 11:

Server aggregates and normalizes incoming data.

Server receives, as input, the request containing the raw prompt sentence, structure, target information, and emotion-related data.

Server parses the payload, validates data types and lengths, and stores the elements into internal data structures, such as session records or temporary tables.

Server may normalize text (for example, unify line endings, remove control characters) and convert timestamps to a standard format.

Server outputs a normalized session context that encapsulates all user inputs for subsequent processing.

Step 12:

Server performs emotion recognition.

Server takes, as input, the emotion-related data (images, audio features, text snippets).

Server feeds image data into a convolutional network, audio features into a recurrent or transformer-based network, and text into a text encoder, producing feature vectors for each modality.

Server concatenates or otherwise combines these vectors in a fusion layer and applies a fully connected classification layer to obtain probabilities for emotion categories such as tension, anxiety, stability, joy, and high interest.

Server selects the highest probability label as the current emotion state and may smooth it over time using a moving average of previous outputs.

Server outputs an emotion state object containing the label and confidence scores.

Step 13:

Server determines control parameters based on the emotion state.

Server receives, as input, the emotion state object and the session context.

Server applies decision rules or a learned mapping that converts the emotion state into quantitative parameters, including desired maximum prompt token count, compression strength, target detail level, and style indicators (for example, “empathetic,” “neutral”).

Server may, for instance, set a lower maximum token count and higher compression strength when the emotion is “anxious,” or allow higher detail when the emotion is “high interest.”

Server outputs a set of control parameters that guide subsequent natural language processing.

Step 14:

Server merges the template structure, raw prompt, and target information.

Server takes, as input, the structured representation, the raw prompt sentence, the target information, and the pre-loaded template definitions.

Server reconstructs a full logical prompt object that includes role specification, task description, constraints, output formatting requirements, and a data section for the target information.

Server combines these elements into a single intermediate text that explicitly separates sections, for example, by adding headings such as “Role,” “Task,” “Constraints,” and “Data.”

Server outputs an intermediate prompt text that is richer and more verbose than the final version.

Step 15:

Server performs linguistic analysis of the intermediate prompt.

Server receives, as input, the intermediate prompt text and the target information text.

Server applies tokenization, part-of-speech tagging, and dependency parsing, and optionally named-entity recognition using trained language models.

Server constructs syntactic trees and dependency graphs to capture relations between clauses, modifiers, and entities.

Server outputs annotated text structures that identify essential and non-essential phrases, clauses, and entities.

Step 16:

Server executes compression processing using natural language processing.

Server takes, as input, the annotated text structures and the control parameters, including the desired compression strength and maximum token count.

Server removes or rewrites text segments classified as redundant, such as repeated explanations or non-critical modifiers, while ensuring that role descriptions, task statements, and constraints remain intact.

Server may use a summarization submodule to condense long “Data” sections to a shorter form that preserves key entities and relationships.

Server simulates tokenization using the tokenizer of the target generative AI model and iteratively adjusts compression until the token count falls within the specified budget.

Server outputs a compressed prompt text that captures the same essential intent with fewer tokens.

Step 17:

Server adjusts composition, detail, and style based on emotion.

Server takes, as input, the compressed prompt text and the style-related control parameters derived from the emotion state.

Server adjusts sentence structures, for example, by converting complex sentences into shorter sentences for anxious users, or by adding clarifying phrases and examples for interested users.

Server modifies wording to match the desired style; for instance, the server can insert brief reassurance such as “Provide clear and calm explanations” when the emotion indicates anxiety.

Server outputs an emotion-adapted, compressed prompt sentence that is ready to be given to the generative AI model.

Step 18:

Server constructs the final prompt payload for the generative AI model.

Server receives, as input, the emotion-adapted prompt sentence and any necessary context from previous interactions.

Server organizes the data into the generative AI model's required format, for example, composing a “system” message that states the role and guidelines, and a “user” message that contains the core prompt and summarized data.

Server sets model parameters such as maximum response tokens and temperature according to policy or control parameters.

Server outputs a structured prompt payload ready for submission to the generative AI model.

Step 19:

Server sends the prompt payload to the generative AI model and receives a response.

Server takes, as input, the final prompt payload.

Server transmits the payload via an API call to the generative AI model host, waits for completion, and receives a text-based response sequence.

The generative AI model internally processes the tokens using a multi-layer transformer, applying self-attention and feed-forward computations to generate successive tokens until stopping criteria are met.

Server outputs a raw response text produced by the generative AI model.

Step 20:

Server performs post-processing on the response information.

Server receives, as input, the raw response text and the current emotion state.

Server applies natural language processing to identify structural elements such as headings, bullet lists, action items, and explanatory paragraphs.

Server reorganizes the content according to emotion-driven rules; for example, for an anxious user, the server extracts and places key action steps at the beginning and trims long background sections; for a highly interested user, the server retains more detail and may add section labels.

Server outputs a formatted response text that is structured and sized appropriately for the user's cognitive state and the terminal's display.

Step 21:

Server transmits the processed response to the terminal.

Server takes, as input, the formatted response text and any associated metadata (for example, emotion label, timestamp, reference ID).

Server serializes these into a response message, typically in a structured format with separate fields for main text, highlights, and metadata.

Server sends the response message to the terminal over the network.

Server outputs a network response that allows the terminal to present the information.

Step 22:

Terminal presents the response to the user.

Terminal receives, as input, the response message from the server.

Terminal parses the message and populates a user interface view, such as sections for “Summary,” “Details,” and “Recommended Actions,” using the display and optional audio output.

Terminal may highlight critical items with graphical indicators and provide controls such as “Show more detail” or “Request clarification.”

Terminal outputs a visual and, if enabled, auditory representation of the generated answer for the user.

Step 23:

User reviews the response and may issue a follow-up instruction.

User takes, as input, the displayed or spoken information.

User decides whether additional clarification or further analysis is needed and, if so, interacts with the terminal by typing a follow-up question or by selecting buttons such as “Clarify this point” or “Focus on encryption measures.”

User's action produces new textual input that refines or extends the original request.

User outputs updated instruction data that the terminal can use to construct a new or incremental prompt.

Step 24:

Terminal and server handle follow-up interactions using updated emotion data.

Terminal collects, as input, the follow-up text and new sensor data reflecting the current emotion.

Terminal sends this updated data to the server, which repeats emotion recognition, parameter determination, compression, and prompt construction as described in previous steps, taking into account prior context.

Server processes the follow-up prompt with the generative AI model and returns additional or refined responses.

Terminal outputs updated responses, thereby enabling an iterative, emotion-adaptive dialog while maintaining efficient token usage and controlled computational load.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

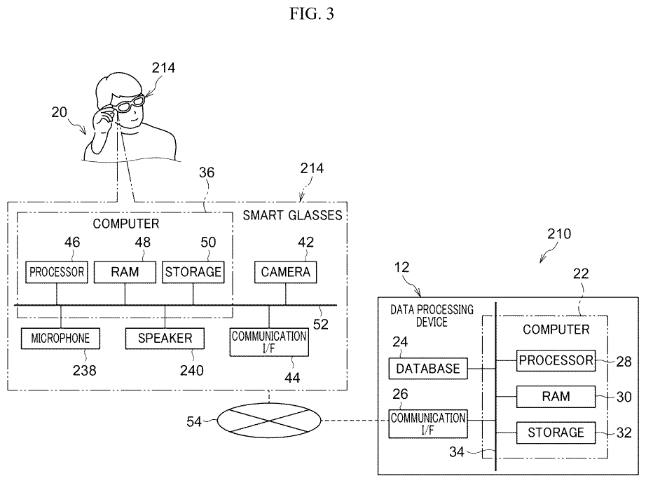

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

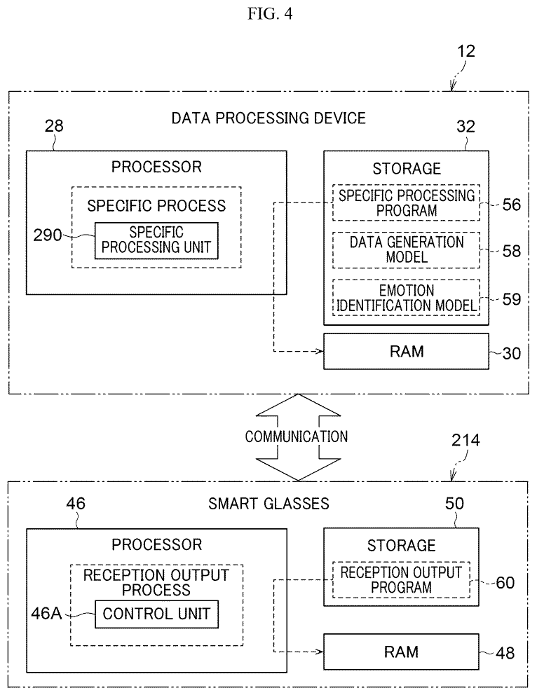

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

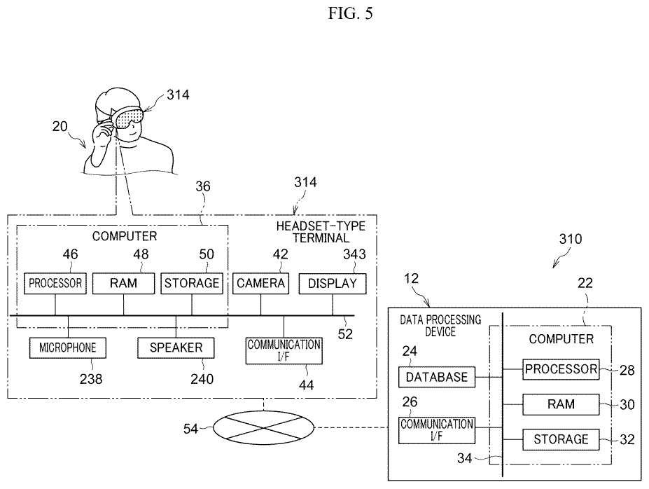

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

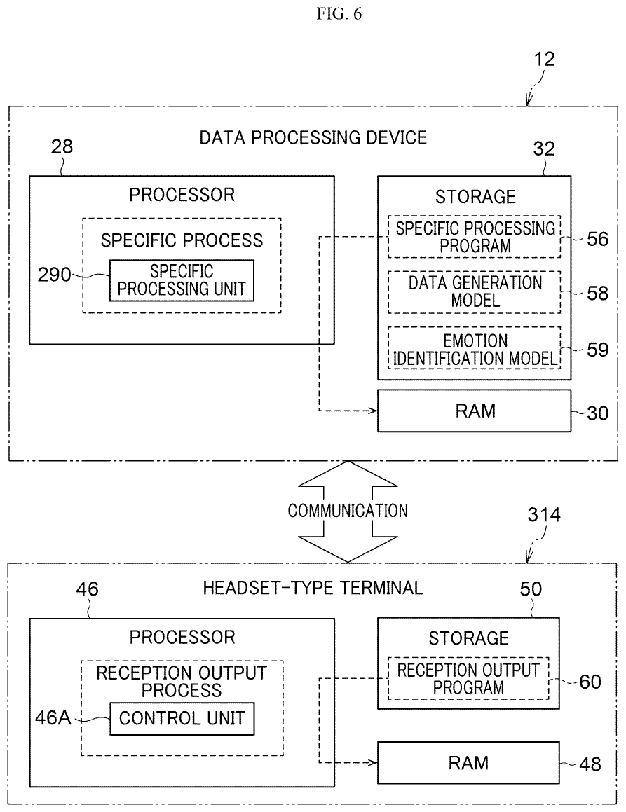

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

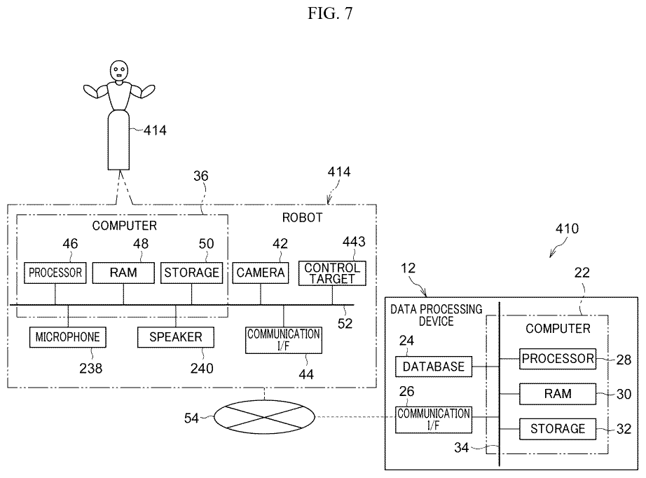

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

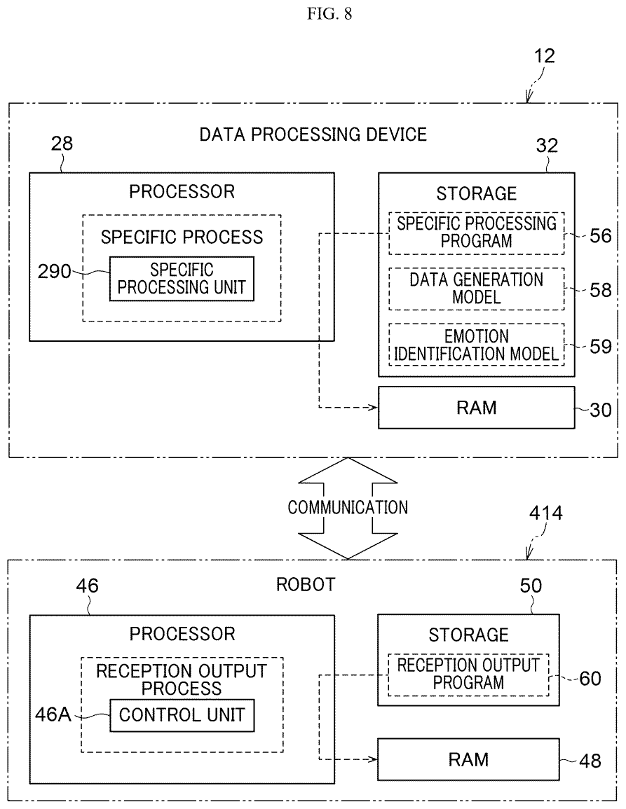

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

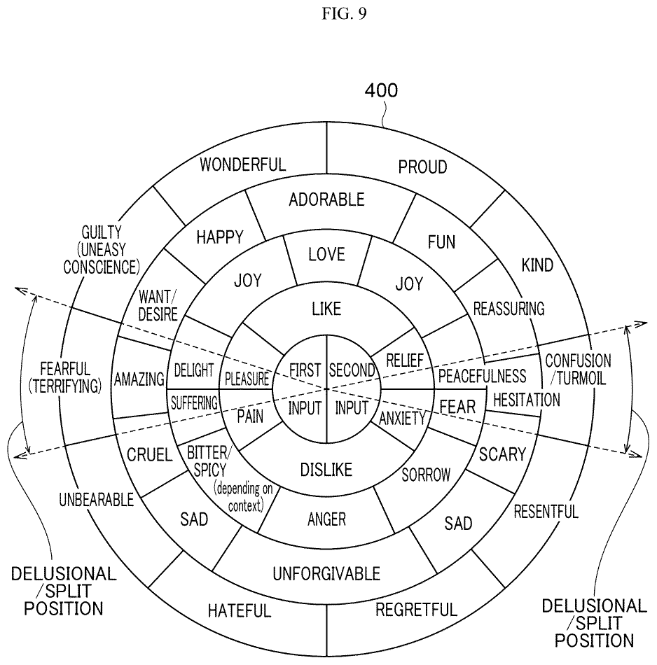

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

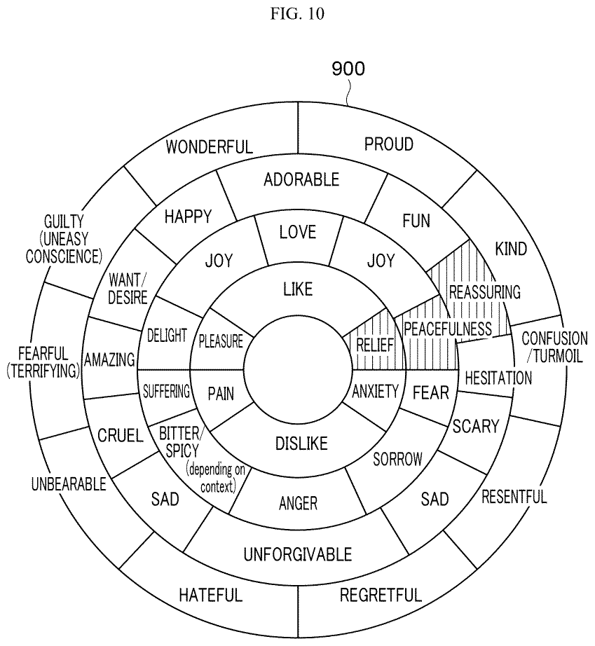

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to distribute, via a communication network to a user terminal, template information including generation block information for constructing a prompt sentence for a generative AI model,

wherein the processor is configured to cause the user terminal to execute a visual block arrangement interface that maintains the generation block information as an abstract structure in response to user operations for selecting, arranging, and editing blocks, to sequentially generate a natural language prompt sentence from the abstract structure, to present the generated prompt sentence to a user in a displayable format, and to transmit the generated prompt sentence to a server,

wherein the processor is configured, at the server, to receive the prompt sentence and to calculate a token sequence by performing segmentation corresponding to the generative AI model, and to execute a compression process on the token sequence based on rules including reduction of redundant expressions, shortening of fixed expressions, and conversion into a structured representation indicating a role, a task, and an output format, thereby generating a compressed prompt sentence and obtaining a token count and a compression ratio before and after compression,

wherein the processor is configured, at the server, to dynamically control compression of the prompt sentence by changing at least one of application, strength, and transformation rules of the compression process based on at least one of the token count before and after compression, the compression ratio, a processing load of the system, and a usage condition of the system,

wherein the processor is configured, at the server, to transmit the compressed prompt sentence to the generative AI model, to receive a response text generated by the generative AI model, to perform post-processing on the response text including at least one of formatting, structuring, and conversion of a display format, and to transmit a post-processed response text to the user terminal, and

wherein the processor is configured, at the user terminal, to display the received response text, to accept, in response to a user evaluation or re-editing request with respect to the response text, at least one of addition, deletion, and content modification of the blocks, and to perform an iterative process of regenerating a new prompt sentence based on an updated block configuration and retransmitting the new prompt sentence to the server.

### (Supplementary 2)

The system according to supplementary 1,

wherein the processor is configured to include, in the template information, a role designation block that instructs the generative AI model to act as an expert in a specific field and a translation function block that converts target content of the prompt sentence into a different language, and to cause the visual block arrangement interface to combine the role designation block and the translation function block with other blocks to construct the abstract structure, and to generate, based on the abstract structure, the prompt sentence including a role designation and translation conditions.

### (Supplementary 3)

The system according to supplementary 1,

wherein the processor is configured, at the server, to adjust at least one of the rules and the strength of the compression process such that a token count of the compressed prompt sentence falls within a predetermined range, thereby reducing an input token count to the generative AI model and improving overall processing efficiency and resource utilization efficiency of the system.

### Application Example 1

### (Supplementary 1)

A system comprising a processor,

wherein the processor is configured to

provide, from an information processing device to a user terminal, generation-support templates and configuration information of a block-assembly language, and

cause the user terminal to generate structured data of a prompt sentence in accordance with selection and arrangement of visual blocks based on the templates, and to transmit the structured data to the information processing device, and

convert, in the information processing device, the structured data into a text string to generate the prompt sentence, and execute compression processing on the generated prompt sentence to reduce data length and lower a token usage rate, and

estimate, in the information processing device, an emotional state of a user on the basis of operation information or biometric information acquired from the user terminal, and

dynamically adjust at least one of a wording structure of the prompt sentence and a compression ratio of the compression processing in accordance with the emotional state, and transmit, from the information processing device, the prompt sentence after the compression processing or a prompt sentence reconstructed on the basis of the prompt sentence after the compression processing to a generative AI model, and receive generated content from the generative AI model and transmit the generated content to the user terminal, and

cause the user terminal to convert the generated content into display data and present the display data visually to the user.

### (Supplementary 2)

The system according to supplementary 1,

wherein the processor is configured to

provide, as elements of the block-assembly language in the information processing device or the user terminal, a role-setting block for specifying a role assigned to an information processing model in the prompt sentence and a translation-processing block for causing contents of the prompt sentence to be converted into another language, and to generate the prompt sentence in accordance with a combination of the role-setting block and the translation-processing block.

### (Supplementary 3)

The system according to supplementary 1,

wherein the processor is configured to

reduce a number of tokens used in communication with the generative AI model by, in the compression processing of the prompt sentence in the information processing device,

reducing representational redundancy of the prompt sentence while maintaining information content of the prompt sentence, thereby improving processing efficiency of the system.

### Example 2

### (Supplementary 1)

A system comprising a processor,

wherein the processor is configured to

present an information structure to a user and distribute a template that defines a framework for assigning a role and operation content to a generative information processing apparatus by using the information structure, and

generate structural information of a prompt sentence including instruction content for the generative information processing apparatus by analyzing, based on a component-assembly language, a plurality of functional elements input by the user and integrating the functional elements into the template, and

generate, as text data, a prompt sentence including a role definition relating to a specialized field, a response policy, and an instruction relating to translation or explanation of target information, on the basis of the structural information, and

convert the text data into a code sequence and compress the code sequence by a lossless compression scheme to reduce an amount of information units so as to lower an information unit usage rate of the prompt sentence, and

measure an amount of information or a number of information units before and after compression, and control generation efficiency and processing efficiency of the prompt sentence by adjusting an application method of the component-assembly language or an expression of the prompt sentence based on a measurement result, and

transmit the compressed prompt sentence or a decoded prompt sentence to the generative information processing apparatus, and provide response information acquired from the generative information processing apparatus to the user.

### (Supplementary 2)

The system according to supplementary 1,

wherein the processor is configured to

include, in the component-assembly language, a role designation element for assigning to the generative information processing apparatus a role relating to a specific specialized field, a translation element for converting contents of the prompt sentence between different natural languages, and a preview element for previously generating candidate prompt sentences and presenting the candidate prompt sentences to the user in an editable form.

### (Supplementary 3)

The system according to supplementary 1,

wherein the processor is configured to

store, prior to generation and compression of the prompt sentence, the information structure, the template, the functional elements based on the component-assembly language, numbers of information units before and after compression, and processing results by the generative information processing apparatus in association with one another, and dynamically reset a configuration of a subsequent prompt sentence and compression conditions based on stored contents so as to reduce a number of information units of the prompt sentence and improve processing efficiency of the system.

### Application Example 2

### (Supplementary 1)

A system comprising a processor,

wherein the processor is configured to

distribute structure information for instruction generation to a user terminal, the structure information including templates and structural elements used for constructing a prompt sentence,

generate a prompt sentence for instructing a generative information processing model to perform a predetermined processing, by using a language representation that visually combines structural elements, based on structure information selected by a user and target information input by the user,

perform a compression processing using natural language processing on the generated prompt sentence and the target information, in order to reduce a number of tokens and improve input efficiency to the generative information processing model,

identify an emotion state of the user by using an emotion recognition model that estimates the emotion state of the user based on at least one of image information, audio information, and character information,

dynamically modify, according to the identified emotion state of the user, at least one of a composition, a level of detail, a compression ratio, and a style of the prompt sentence, so as to control a cognitive load of the user and a token usage rate of the generative information processing model,

generate a final prompt sentence that reflects the emotion state and the compression processing in accordance with an input and output format of the generative information processing model, and transmit the final prompt sentence to the generative information processing model, and

perform post-processing on response information obtained from the generative information processing model by at least one of summarizing, structuring, and rearranging the response information according to the emotion state of the user, and provide a result of the post-processing to the user terminal.

### (Supplementary 2)

The system according to supplementary 1,

wherein the processor is configured to

use, as the language representation that visually combines the structural elements, structural elements including a role designation element, a processing content designation element, a constraint condition designation element, and an output format designation element, assign a virtual role having specialized knowledge as the role designation element, and include a translation processing in the processing content designation element so as to convert contents of the prompt sentence into a different symbol system.

### (Supplementary 3)

The system according to supplementary 1,

wherein the processor is configured to

control the compression processing using natural language processing so that the compression processing reduces redundant expressions while preserving meaning by performing at least one of morphological analysis, syntactic analysis, and summarization, increases the compression ratio to simplify the prompt sentence when the emotion state indicates tension or anxiety, and decreases the compression ratio to make the prompt sentence more detailed when the emotion state indicates stability or a high level of interest.

What is claimed is:

1. A system comprising:
circuitry configured to:
distribute, to a client terminal via a packet-switched network, template information comprising generation block information for constructing a prompt sentence for a generative neural network model;
receive, from the client terminal, an abstract structure generated by arranging a plurality of functional blocks according to a block-based language, each functional block having a defined function and associated parameters;
generate a prompt sentence in natural language from the abstract structure by sequentially processing the plurality of functional blocks and integrating outputs of the functional blocks according to the block-based language;
calculate a token sequence by performing segmentation of the prompt sentence corresponding to an input format of the generative neural network model, and execute a compression process on the token sequence to generate a compressed prompt sentence with a reduced token count;
transmit the compressed prompt sentence to the generative neural network model via the packet-switched network and receive a response text from the generative neural network model; and
perform post-processing on the response text and transmit a post-processed response to the client terminal via the packet-switched network.

2. The system according to claim 1, wherein the circuitry is configured to execute the compression process by applying rules comprising reduction of redundant expressions in the token sequence, shortening of fixed expressions, and conversion of descriptive text into a structured representation indicating a role, a task, and an output format, and to compute a compression ratio based on the token count before and after compression.

3. The system according to claim 2, wherein the circuitry is configured to dynamically control the compression process by adjusting at least one of application scope, compression strength, and transformation rules based on at least one of the token count, the compression ratio, a processing load of the system, and a token limit of the generative neural network model.

4. The system according to claim 3, wherein the circuitry is configured to adjust the compression strength such that the token count of the compressed prompt sentence falls within a predetermined range, and to verify that semantic content of the compressed prompt sentence preserves essential instructions from the original prompt sentence by comparing extracted key terms before and after compression.

5. The system according to claim 4, wherein the circuitry is configured to evaluate a quality of the response text by comparing the response text against expected output characteristics derived from the abstract structure, and to adjust the transformation rules for subsequent compression processes based on the evaluation to improve response quality.

6. The system according to claim 1, wherein the circuitry is configured to include, in the template information, a role designation block that instructs the generative neural network model to operate as an expert in a specified field, and a translation function block that converts target content of the prompt sentence into a different language, such that the prompt sentence generated from the abstract structure includes a role designation and translation conditions.

7. The system according to claim 6, wherein the circuitry is configured to process the role designation block by inserting a role instruction segment at a beginning of the prompt sentence, and to process the translation function block by appending a language conversion directive specifying a source language and a target language to the prompt sentence.

8. The system according to claim 7, wherein the circuitry is configured to apply the compression process to the prompt sentence while preserving the role instruction segment and the language conversion directive as protected segments that are not subject to reduction or shortening.

9. The system according to claim 1, wherein the circuitry is configured to receive, from the client terminal, a modification request comprising at least one of addition, deletion, and content modification of the functional blocks in the abstract structure, regenerate a new prompt sentence based on an updated abstract structure, execute the compression process on the new prompt sentence, and retransmit the compressed new prompt sentence to the generative neural network model.

10. The system according to claim 9, wherein the circuitry is configured to identify, in the updated abstract structure, functional blocks that are unchanged from the prior abstract structure, retrieve cached compression results for the unchanged functional blocks, and apply the compression process only to functional blocks that were added or modified, thereby reducing computational overhead of the iterative regeneration.

11. The system according to claim 10, wherein the circuitry is configured to maintain a version history comprising each abstract structure, the corresponding prompt sentence, the compressed prompt sentence, and the response text, and to enable the client terminal to revert to a prior version in the version history.

12. The system according to claim 1, wherein the circuitry is configured to recognize an emotional state of a user based on interaction pattern data received from the client terminal, and to adjust at least one of generation parameters of the prompt sentence and the compression strength based on the recognized emotional state.

13. The system according to claim 12, wherein the circuitry is configured to adjust, when the emotional state indicates frustration, the generation parameters to produce a simplified prompt sentence with fewer functional blocks active, and to reduce the compression strength to preserve clarity of the instructions transmitted to the generative neural network model.

14. The system according to claim 1, wherein the circuitry is configured to provide, to the client terminal, a visual block arrangement interface that displays the functional blocks as graphical elements and enables the user to select, arrange, and connect the graphical elements to construct the abstract structure, and to transmit the abstract structure generated by the visual block arrangement interface to the circuitry for prompt sentence generation.

15. The system according to claim 14, wherein the circuitry is configured to display, within the visual block arrangement interface, a real-time preview of the prompt sentence being generated from the current arrangement of graphical elements, and to display the token count and the compression ratio alongside the preview.

16. The system according to claim 1, wherein the circuitry is configured to perform the post-processing on the response text by executing at least one of formatting the response text into a structured document, extracting key information segments from the response text, and converting a display format of the response text based on a presentation specification received from the client terminal.

17. The system according to claim 1, wherein the circuitry is configured to accumulate, in a storage medium, correspondence data among the abstract structures, the prompt sentences, the compressed prompt sentences, and user evaluation data indicating quality of the response texts, and to analyze the correspondence data to identify block arrangements associated with high-quality responses for use in improving the template information.

18. A system comprising:
circuitry configured to:
distribute template information comprising generation block information to a client terminal via a packet-switched network;
receive an abstract structure generated from a plurality of functional blocks arranged according to a block-based language;
generate a prompt sentence in natural language from the abstract structure;
execute a compression process on the prompt sentence to generate a compressed prompt sentence with a reduced token count;
recognize an emotional state of a user and adjust at least one of the prompt sentence and compression parameters based on the emotional state;
transmit the compressed prompt sentence to a generative neural network model via the packet-switched network and receive a response text; and
perform post-processing on the response text and transmit a post-processed response to the client terminal via the packet-switched network.

19. The system according to claim 18, wherein the circuitry is configured to receive a modification request from the client terminal, regenerate a new prompt sentence based on an updated abstract structure, execute the compression process on the new prompt sentence, and retransmit the compressed new prompt sentence to the generative neural network model.

20. A method performed by circuitry, the method comprising:
distributing template information comprising generation block information to a client terminal via a packet-switched network;
receiving an abstract structure generated from a plurality of functional blocks arranged according to a block-based language;
generating a prompt sentence in natural language from the abstract structure;
executing a compression process on the prompt sentence to generate a compressed prompt sentence with a reduced token count;
transmitting the compressed prompt sentence to a generative neural network model via the packet-switched network and receiving a response text; and
performing post-processing on the response text and transmitting a post-processed response to the client terminal via the packet-switched network.
